(19) United States
(12) Patent Application Publication
(10) Pub. No.: US 2008/0136775 A1
(43) Pub. Date: Jun. 12, 2008

(54) Virtual input device for computing

(76) Inventor: Carson V. Conant, Glenview, IL (US)

Correspondence Address: BELL, BOYD & LLOYD, LLP, P.O. Box 1135, CHICAGO, IL, 60690, US

(21) Appl. No.: 11/636,228

(22) Filed: Dec. 8, 2006

(51) Int. Cl. G09G 5/00

(52) U.S. Cl. 345/156

(57) ABSTRACT

A virtual input device or apparatus that replaces the typical mouse, keyboard or other finger manipulated inputs currently used as inputs for any type of computing system such as signals used to control computers, PDAs, Video Games, Multimedia Displays and other similar electronic systems whether of a desktop or mobile configuration.

### FIELD OF THE INVENTION

The present invention generally relates to a virtual input device and, more particularly to a virtual input device that replaces the typical mouse, keyboard, switches, dials, buttons, touch-screens, and other finger manipulated input devices currently used as inputs for any type of computing such as input signals used to control computers, PDAs, MP3 Players, Video Games, Stereos and other Audiovisual Components, Home/Office Appliances, Multimedia Displays and other similar electronic systems whether of a desktop or mobile configuration.

### BACKGROUND OF THE INVENTION

With a growing trend of adopting and using mobile devices by the public, there is and will continue to be a need for more efficient input computing systems and methods for all types of data entry and computer commands to enhance the communications, user-interface, and computing efficiency of these mobile computing systems like laptop computers, micro-computers, video games, PDAs, MP3 players, iPods, cells phones, digital cameras as well as the traditional desktop computer, stereo and audiovisual components, home and office appliances, multimedia wall computing displays, industrial machines and computing systems, healthcare systems, and others. As these devices (and/or their attendant display interfaces) become smaller and more portable they are transitioning from larger computing devices with traditional operational input methods, such as a desktop keyboard and mouse to ever smaller input methods, such as a tiny keyboards, tiny touch-screens, and styluses. To continue to achieve smaller devices, and even to nano-sized computing systems in the future, there exists a problem. The problem is how to enter data, input commands into, and interact with these computing systems and display devices as they continue to shrink in size making it more difficult for normal data entry and commands by these traditional methods of keyboards and mouse operational input devices in order to operate these computing devices and then display the relevant information or even interact with the video displays while controlling the computing systems. In fact, the digits on a hand of the end user are often too large to operate the minute controls on many currently available electronic device(s) like a credit card radio, razor thin digital cameras or similar electronic device(s), or they require certain concessions be made by engineers in order to facilitate these methods of data input and user-interaction, such as dedicating a relatively large portion of the device's face to the input method.

For example, with the advent of rechargeable lithium batteries of a thin flat configuration, digital cameras, PDAs and cell phones have become smaller and thinner such that power on/off, channel selection, volume and other control buttons or switches have become as small as can be reasonably manipulated by human hands. Engineers struggle between maximizing visual display area on portable devices while maintaining usability. Many of the PDA manufacturers have tried to solve this problem by implementing a stylus input method whereby users can write on the screen and such motions are translated into standard inputs (e.g. numbers, letters, etc.). However, the stylus method is significantly less efficient than a keyboard and not functional for large amounts of data input, such as writing a novel. Current electronic devices have achieved a respectable degree of user ability while also achieving a small size factor. However, as computing devices take the next logical leap of reduction in size and increased mobility the reliance on the traditional keyboard and mouse, stylus or touch-screen input device combinations to interact with computing devices for data entry and commands will become impractical and outmoded.

It is becoming more common for computing displays to be integrated into contact lenses, eye glasses, car windshields, house/office/store windows, or floating holograms like those already offered on some cars now that are projected out into the space in front of the windshields including a virtual odometer and night vision sensing to detect obstructions or potential collisions with other vehicles. One limitation on these new type of computing systems and attendant displays are the imagination of mankind to dream up the new operational input devices that will be needed in the future. For example, a user wearing computer-interface glasses that wireless connect to the internet can see all the relevant computer information, such as email, calendar, etc., projected in front of her. This user is freed from the current confines of looking down at a tiny device or carrying around a larger computer. However, when it comes time to interact with this information a physical keyboard, mouse, stylus or any similar input method would not achieve the same level of efficiency. What is required is a new means for interacting with the revolutionary microcomputers and heads-up-displays of the future as well as improving the user interface with current computing devices.

So the present invention, which relates to a virtual input device that is ideally suited for wireless or wired communication for computer data entry and commands that are used with a desktop and mobile computer, PDAs, mobile multimedia devices (iPods, cell phones and portable TVs), stereo, audiovisual components, home/office appliances, multimedia computing wall displays, industrial computing systems, healthcare systems, military computing systems, video games, or the like and, more particularly, to a three-dimensional (3D) virtual input device that provides a high-operability man-machine interface environment for the user Collectively the electronic and computing devices which can interface and accept inputs from the virtual input device are referred to interchangeably as “computing devices(s)” or “electronic device(s)” hereinafter.

Examples of just such an input devices more suitable for use with some of the new computing systems are shown in U.S. Pat. Nos. 6,515,669, 6,380,923, 5,670,987 and US 2005/0243060 publication that deal with fingertip transmitters, RFID devices on finger tips, finger sensors and fingertip transducers, respectively. Both the '669 and 987 patents disclose the typical three-dimensional sensing of finger positioning and the algorithms and flowcharts of the systems capable of being used with these types of devices in general. The '669 and '987 patent disclosures on the operations of a three-dimensional sensing system are incorporated herein by reference thereto. But these patents lack the ability to receive low level output signals from a passive or active transmitter generating an electromagnetic signal, such as radio, microwave, infrared, ultraviolet, x-ray, and/or gamma ray frequencies (“Transmission(s)”) located on a fingernail, finger, hand, arm or other extremity of the body like the present invention to produce spatial information that can be transformed into commands or control signals to operate a variety of electronic devices.

The present invention also relates to a virtual input device for computing that applies to a gesture (spatial motion pattern) input system for implementing an expanded input function based on operation patterns and motion patterns of an operator's body. For example, a user might make a fist and punch the air with a hand that automatically calls for a video game algorithm to now control the computing system, thereby allowing the user to play the game by using his hand with transmitter(s) as the joystick as similarly described in the specification and as shown in FIG. 14 in the '669 patent.

As a conventional computer input device to which an operation input device of this type is applied, for example, an operation system is disclosed in Japan. Pat. Application. KOKAI Publication No. 7-28591. According to this operation system, the function of a conventional two-dimensional mouse is expanded by incorporating an acceleration sensor or the like into the two-dimensional mouse as in a 3D mouse or space control mouse, thereby using the two-dimensional mouse as a three-dimensional input device. In addition, as a device using a scheme of measuring the extent of bending of each finger or palm of the operator with optical fibers and resistive elements mounted on a glove, a data glove or the like is commercially available (Data Glove available from VPL Research; U.S. Pat. Nos. 4,937,444 and 5,097,252).

Japan. Pat. Application. KOKAI Publication No. 9-102046 discloses another device designed to detect the shape, motion, and the like of the hand by an image-processing scheme. In using the above operation system like a 3D mouse, since the function of the two-dimensional mouse is expanded, the operator must newly learn a unique operation method based on operation commands for the mouse. This puts a new burden on the operator. In a device like the above data glove, optical fibers and pressure-sensitive elements are mounted on finger joints to detect changes in the finger joints in accordance with changes in light amount and resistance. For this purpose, many finger joints must be measured. This complicates the device and its control system. To wear a device like a data glove, calibration or initialization is required to fit the shape of the hand of each user. That is, not every person can readily use such a device because the glove might not fit his or her hand well. If the glove greatly differs in size from the hand of a person, they cannot use it or the sensor signals would not line up for proper use. When the user wears such a device, there is the feeling of being restrained because of the glove-like shape of the device that is worn over the fingers on each hand. In addition, since the fingertips and the like are covered with the material of the particular glove with its device, delicate work and operation with the fingertips are hindered because the user lacks the tactile feel of touching objects directly with the flesh of the fingers. Therefore, the user cannot always wear the glove device during an operation. In the scheme of detecting the shape, motion, and the like of the hand by the above image processing, a problem arises in terms of the camera position at which the image is captured, and limitations are imposed on the image captured at the position, resulting in poor mobility and portability. Furthermore, the processing apparatus and system for image processing are complicated. As described above, the respective conventional operation systems have various problems.

### BRIEF SUMMARY OF THE INVENTION

To improve the inputting of data and information into mobile and stationary computing systems, several inventors have offered creative solutions such as gloves or finger sensor rings that monitor finger movements to simulate keyboard strokes (U.S. Pat. No. 5,581,484 to Prince and U.S. Pat. No. 6,380,923 to Fukumoto, et al, respectively). Another invention projects a keyboard on a physical surface, which a user can then type upon to imitate the traditional keyboard for a computer. Still other inventions show a virtual input apparatus device for computer and video games in which the mouse control is located on the index finger with a miniature toggle switch paralleling the motion of a mouse on a desk pad or similar to the toggle stick on a laptop computer's keyboard that replaces the traditional mouse device as found in U.S. Pat. No. 7,042,438. Still another patent U.S. Pat. No. 6,515,669 discloses fingertip transmitters and spatial motion with respect to a back of the hand receiver to determine the commands to be inputted into its system. However, these prior art patents are representative of the prior art but none of them teach or suggest the inventive concept of the present invention.

Moreover, none of these input devices will provide an adequate input for the existing and smaller computing systems to follow on in the future. Therefore, a special need exists for a virtual input device capable of interfacing with the existing computing systems of today and those of the future because users of existing and future computing systems will need an input method that is always with them and can easily interface with a multitude of computing devices and their attendant displays much like the universal remote controls of today for TVs. However, the big differences here is that the virtual input device and system of the present invention is capable of being carried on the person body without interfering with their everyday routines when they are not using a computing system and their attendant display for personal or professional needs. Just as a myriad of devices can receive inputs from traditional remote controls, any device or software could be designed to accept inputs from a virtual input device in order to facilitate user-control of the devices.

A virtual input device and system according to the present invention for inputting into various existing and future computing systems that provides for inputting data and commands to control the computing system and its output display includes an entirely new input device and system for inputting to computing systems over the traditional keyboard and mouse inputs. With the present invention, a user affixes small transmitter(s) to various body parts of the user such as a hand, its fingers, fingernails, arm and leg or even an article of clothing on the body. Each transmitter sends out a unique signal (e.g. Radio Frequency (“RF”), microwave (“MW”) or other electromagnetic signal, collectively “Transmissions”, which is measured and monitored.

This is especially true today for Transmission signal sources, which are capable of generating a variety of rather unconventional signals for evolving wireless communications systems and methods. One such source for the transmission of RF signals among many is an active or passive Radio Frequency ID (“RFID”) tag. Another source of signals could be a traceable isotope of a predetermined detectable radiation or the like. These active or passive transmitters could be designed to broadcast in any frequency range.

Turning now to one source of RF signals that are usable in the present invention, the RFID tags are generally either passive or active transmitters. The passive RFID tags have no internal power supply whereas the active RFID tag is powered by a local power source, such as battery that generally lasts up to a year or more of life, or a renewable power source, such as a solar or motion, which would continuously charge the transmitter. The RFID tag typically comes in a film or chip version, which are both easily adapted as a usable transmitter. In the passive version of the tag, the source receiving the signal activates the transmitter and then receives its output signal in response thereto. In the active tag version, the transmitter is either continuously generating an output signal or actively generates an output signal at desired times, such as but not limited to coming in proximity to another transmitter or being located at a desired spatial location.

Another source for a transmitter output signal is an isotope that generates a detectable radiate output signal. There are many different isotopes that generate a controlled and harmless radiation that are usable as an active output signal source of a predetermined lifespan as a transmitter

A receiver is then tuned to the appropriate transmission frequency (e.g. radio frequency) and the transmission signals are used to determine the position of each transmitter relative to the other transmitters and/or relative to a specific point (e.g. the receiver). The receiver is generally connected to an input/output (“I/O”) module of a computing device or it is a device that communicates with a computing device through a standard connection and communication methods (e.g. PS2, USB, Bluetooth, FireWire, Wi-FI, WiMax, Serial, Parallel, Infrared, Radio Frequency, etc.). A combination of these communication methods in conjunction with a microprocessor may be used to generate a modulated carrier output signal, which conveys digitally encoded information in accordance with a variety of application-specific standards to form the command or control signals for the electronic devices to be controlled.

In one embodiment of the invention, the receiver associated with a microprocessor might be warn as a bracelet or a watch (Suunto watches for example contain both a receiver and microprocessors with flash memory), which are capable of receiving position data and then having their microprocessor determine the relative position of the transmitters during their travel through various motions and then relaying that data or command information to another device like a computer via a Bluetooth or similar wireless communication method.

It is often the case that the transmitters will be located on user's fingertips because such locations provide a plurality of highly controllable points of transmission because the human hand is so dexterous. There are nearly infinite finger/hand position and motion combinations that can be translated into computing inputs. However the present invention allows for the transmitters to be located at any point on the body, clothing, or apparatuses, and in any quantity as to achieve a desired user input experience or function. For simplicity the multitude of transmitter motions are often referred to simply as “finger manipulations” because these account for one of the most common uses, but such description is meant to provide a simple understanding and is not meant to limit such description of the invention to only finger-located transmitters.

An advantage of the virtual input device or apparatus of the present invention is that it may be used to interact with multiple devices having a software program adapted and capable of interpreting finger manipulations as entry data or input commands to a chosen computing system of an electronic device. The program controlling the particular desired functions are readily stored in a memory means, such as on an erasable programmable read-only memory (EPROM) or an electrical erasable programmable read-only memory (EEPROM) or a flash memory that is less expensive than either the EPROM or EEPROM. Flash memory has become a widely used technology wherever a significant amount of cheap, non-volatile, sold-state storage memory is needed by devices like digital audio player, digital cameras and mobile phones to mention a few. In the future, there will be other advances in computer memory but essentially, any memory storage means that comes along in the future is a viable candidate to use as the memory with the present invention.

In one embodiment of the present invention, the processor in combination with software resident in the memory of the virtual input device can be programmed to translate the transmitter motions, such as corresponding to various finger manipulations into pre-defined output commands to be used by the computing device. For example, a set finger motion being translated to a digital command equivalent to an input of a particular alphanumeric command (e.g. a letter, number, etc.) or a particular application command (e.g. copy, paste, delete, enter, move, etc.). An example of the above embodiment would be transmitters located on a user's fingertips and a corresponding processor, memory, and software located in an associated Universal Serial Bus (USB) computer accessory. The USB accessory would receive the signals from the fingertip transmitters and translate pre-defined finger manipulations into standard keyboard inputs which are then transmitted to the computer via the USB interface thereby replacing a traditional keyboard with the virtual input device, whereby each keyboard function is represented by a corresponding finger or hand manipulation. For example, pressing the thumb and index finger together might signify the letter “a” to the electronic device. This example is meant to demonstrate the embodiment above rather than limit to this specific example as there are many virtual input device configurations and corresponding computing devices which can employ the above embodiment in a variety of useful ways.

Some electronic devices may include a preloaded command program for interpreting the raw spatial transmitter locations and motions input data from the virtual input device. Therefore, instead of the processor of the virtual input device translating the raw spatial data and interpreting and converting the spatial data into the final command or control signals, the raw spatial data is fed directly into the computing system of the electronic device(s) to be controlled. The electronic device(s) include a memory with the command interpreter program, which interprets the raw spatial data corresponding to the finger motion or manipulation that is converted into control signals to operate the electronic device(s). As the storage capacity of cheap memory keeps expanding from the kilobyte, to gigabytes, and beyond, the Electronic device(s) having the expand memory can run more complex control programs resident therein to develop, expand and/or customize the command or control signals available for the virtual input device.

The above embodiment is useful for complex software applications, which will be designed to use proprietary transmitter motions, which are not standards. For example, a video editing software package could be designed such that raw spatial data relating to complex finger, hand, or other transmitter manipulations are transmitted from the virtual input device to the computing device and made available to the video editing software to be translated into specific proprietary commands. An example of one such command might be a user performing a grabbing motion with his fingers and hand to move one frame of video to another location within the movie. The corresponding transmitter motions are not interpreted by the command interpreter but are instead interpreted directly by the software of the video editing application into the corresponding correct input.

In another variation of the above embodiment the computing device(s) are equipped with a receiver (or receivers) and a corresponding processor to determine the spatial location of the user's transmitters and their corresponding spatial manipulations, such that the computing device possesses the necessary receiver(s), processor and software to receiver and process the raw spatial location into data usable by the resident programs on the computing device. For example, a computer may be equipped with said receiver(s) and when activated the user's transmitters would then act as the input method for controlling the computer, such that that a processor of the computer interprets the transmitter manipulations (e.g. finger manipulations corresponding to textual, mouse input, etc.) and the computing device does not require any external processor to perform any part of the receiving and/or translation of transmitter locations into usable inputs.

Since typical passive transmitters are relatively cheap, rugged and relatively small, the transmitters are often considered to be disposable such that when one falls off or is cut off (e.g. when a user cuts a fingernail), the user simply affixes another transmitter to the appropriate location. The resident software program identifies the replacement transmitter to make sure it is located in the appropriate location and process continues on with minimal interruption.

The transmitters, such as RF or MW transmitters, often send low-level signals, which are easily picked up by a bracelet or watch type receiver located on the wrist of the end user. The bracelet or watch type receivers are often connected directly to the I/O of the microprocessor, which is also incorporated into the bracelet or watch. An example of such a computing system is found in the Suunto brand name of watches for heart or GPS monitoring functions. Such a watch has a powerful receiver and microprocessor with plenty of flash memory with stored programs for a multitude of functions. The finger movements, manipulations and patterns of motion of the user's body result in output signals from the transmitter(s) corresponding to predefined motions that represent certain characters or commands in the computing system. The processor within the bracelet or watch translates those predefined motions from the transmitter(s) output signals into appropriate control signals, which are then outputted through the I/O of the processor to the mobile or stationary computing system of the electronic device for operating the same. The output from the bracelet or watch is often accomplished through direct wired connection, such as USB, FireWire, Serial, Parallel, or similar; or a wireless connection, such as Bluetooth, Wi-FI, WiMax, RF, IR, or similar.

In this embodiment a virtual input device can be incorporated into any wearable accessory, which provides the necessary technical requirements, such as sufficient reception from the transmitters, processor, power, memory for the related program(s), and preferably can be worn discretely. Such accessories could include, but are not limited to belts, backpacks, fanny-packs, clothes, jewelry, necklaces, rings, hats, etc.

The transmitters are designed such that the transmitter stands up to regular wear allowing the users to wear them during most daily activities, rather than attaching them at the time when they are immediately needed. For example, the transmitters may be waterproof, women may be able to wear fingernail polish over the transmitters, athletic users may sweat, play sports, etc., and the passive or active transmitters would continue to operate when needed under normal to extreme environmental conditions. Transmitters could even be implanted surgically beneath the skin of the end user.

In another instance the affixed transmitter does not need to be even a passive or active electrical circuit. If an isotope or some other natural element is used as a transmitter that provides a traceable signal for detection, it is then measured to determine relative location of each finger having a transmitter. Again, the transmitter is easily affixed to the fingernail or skin of the user or surgically inserted under the skin.

In another instances, the same or other transmitters may be affixed to other positions on the user's body to refine or expand the number of input signals to the computing system. For example, in video games, the transmitters could be affixed to knees, legs, feet, etc., to monitor the entire body motion and simulate what the user might do if he is actually participating in the virtual world of the video game.

The operation of a virtual input device according to the present invention is achieved by a new system configuration that imposes no new burden on the user, eliminates the necessity to perform calibration and initialization each time the user activates the device, readily allows anyone to use the device, and allows the user to perform delicate work and operation with his/her fingertips without any interference, and to wear the virtual input device at work, play or asleep in order to achieve the above stated objectives. So the virtual input device of the present invention includes several transmitters with output signals strategically located on the body or clothing of the end user, a receiver and a computing system including memory, processor and programs for transforming and converting the output signals of the transmitters corresponding to spatial movement into command or control signals for operating an electronic device.

Accordingly, there is provided a virtual input device comprising at least two or more transmitters of a de minimus size located on the body or clothing of an end user in a predetermined spaced apart relationship, each transmitter generating a unique signal, a receiver (or receivers) for the reception of each unique signal, a processor connected to the receiver including a spatial recognition program to generate raw spatial data related to the output signals of the transmitters representing the manipulation of the transmitters and/or a command interpreter program transforming the raw spatial data into pre-determined control signals, such as standard keyboard, mouse commands, that are generally wirelessly fed to the I/O of electronic device (or multiple electronic devices simultaneously) to operate the same.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

The users with the affixed transmitters, such as transmitters affixed on their fingers, can interface with devices local to the users. Or, the signals from the transmitters can be delivered to remote computing devices via an Internet, satellite, digital radio transmission, cell phone, or any other wired or wireless digital network communication method. This allows a user to interface as effectively with a computer in his office or home as he can with one accessible anywhere in the world via a network connection.

### OPERATION

One operational method of the present invention, allows for a user to use predetermined finger positions as an input signal method. This could be done letter-by-letter, similar to typing. For example, touching the two index fingers on the left hand together might indicate the letter “a”. Other finger positions would indicate other letters or alternative options. For example, the left hand was held in a fist might indicate that the right index finger should function as a mouse pointer. The user could manually specify the meanings of the motions and the corresponding input of the transmitters, or the user could select a standard.

The above method is a simple example. There are many available ways to program whatever function you desire in any application so a single programmer is often able to write the appropriate functional specification and flowchart from the description provided above for this invention, which then a single individual programmer or a host of different software programmers are able to write the appropriate transmitter positioning software program for the input signals to the predetermined computing system.

This is similar to how software programmers design software for current input methods such as a keyboard, mouse, joystick or other input device. Programmer can accept the default command from the input devices, or devise new commands from inputs. For example, programmers can accept the default use of a mouse moving from left to right as moving a cursor from left to right on the screen. But in another application a programmer can design software such that the mouse moving from left to right results in an entirely different effect, such as banking an airplane in a video game or scrolling a video-editing window. Similarly, software can interpret any of the keys of a standard keyboard to mean the letter corresponding to that key. Or, they can assign entirely different functionality. For example, in video games, often the letters “I”, “J”, “K”, and “L” are interpreted as Forward, Left, Back, and Right respectively. And in many cases, the end user as desired can modify the corresponding function of each key. So, can the virtual input device of the present invention be utilized, whereby the software of the computing device can accept pre-defined commands corresponding to transmitter manipulations, the software can be designed to interpret the transmitter manipulations for a specific application's purpose, and/or the user can modify how transmitter manipulations are interpreted, thereby customizing the virtual input device to his or her liking.

Because there are only ten fingers and over 70 keys on a standard keyboard, various finger combinations would be used to indicate specific inputs. However, a software program similar or identical to the one used for the Blackberry which uses only twenty keystrokes to cover the entire alpha and numeric characters and carriage returns found on the standard keyboard is an example of existing software available for use with the present invention. Other samples of such software programs can be found on bulletin boards and other sources on the web as freeware and in various published textbooks and patents concerning the mobile device software. For example, if the thumb and first two fingers of the right hand were held together and the thumb and first finger on the left hand were held together, this could indicate a specific key with its attendant letter or number. With these various finger combinations as well as other touch finger positions, all letters, numbers, etc. would have a corresponding signal input method representing all of the characters on the keyboard and functions of the mouse. Just like a keyboard, these various schemes of finger movements could be taught to the end user as easy as it is to learn the keyboard strokes. Similarly, PDAs running popular Palm software originally design several years ago by 3COM Corporation for its Palm PDA uses interpretive software to determine the motion of a stylus on a pad to decipher the particular letter entry into the PDA.

The output signal of each transmitter combine various finger and hand positions and motions, such as fingers touching together, fingers touching other points (e.g. thumb touching middle of index finger), finger or hand motions in the air (e.g. the right finger and hand moving in a three dimensional space to indicate mouse movement), or fingers touching other measurable places such as the back of the hand or palm of a hand (e.g. simulating a drawing using the palm of the hand).

Motions also do not need to be in the form of letters, number or other textual inputs only. Applications could be designed that allowed users to “grab” or manipulate objects and move them in a three dimensional space (“3D”) such as video games, holograms or other similar 3D computing applications and attendant displays.

So the present invention includes the ability to represent both the keyboard and the mouse on a computing system through the unique manipulations with respect to the finger or hand positions or motions. Additionally, the present invention can be used to create entirely new input methods that go beyond the breadth, depth, usability, and functionality of traditional input methods.

The present invention accomplishes this feat by using independent wireless transmitters which are affixed to various locations on the body, such as but not limited to, nails of desired fingers and the transmitters, which are often active or passive Radio Frequency transmitters are easily affixed to the desired location and are relatively inexpensive and therefore are disposable and easily replaced if damaged or lost.

The words transmitter or sensor are used interchangeable as defined herein as one of the elements of the present invention which can be located at any place on a user's body, on users accessories, clothes, implements, etc, such that these transmitters allow for the sensing of their respective position relative to other “sensors”. As described in the invention, this “sensor” is essentially a transmitter (e.g. RFID) or it could in itself be a sensor and a transmitter of the transmission signals from the other transmitters located on the other fingers or body locations. So the word “sensor” is a rather broad language term that would include a sensor and/or transmitter.

The present invention can be used to interface with traditional computer systems as well as future computing systems. One such future computing system which works well with the present invention are Heads-Up-Displays.

More users are adopting mobile computing systems, which have the visual computer interface built into their eyeglasses, sunglasses, goggles, military night vision headgear, contact lenses, or other projection-able displays, (often referred to as “heads up displays”). Although these type of computing systems and input devices were often used in military applications, as the costs and size of these devices comes down, they are being adopted for consumer uses, such as personal computing. The present invention allows for efficient interface with the heads-up displays. One such device is the heads-up displays from Micro Optical Corporation. MicroOptical's viewers are amongst the smallest, lightest head-up displays available today. The viewers accept standard VGA, NTSC, PAL, RS170 and RS232 signals and weigh about 1 ounce. The viewers project the information right in front of the end user. The viewer is generally attached to a pair of safety eyeglasses and can project out in front of the left or right eye depending upon the user's preference. MicroOptical's patented optical system in U.S. Pat. No. 6,384,982 gives the user the impression of a free-floating monitor. This unique optical system is what allows the user to maintain natural vision and awareness of the environment. The viewers are plug-and-play, ergonomic, and attach easily to prescription or safety eyewear. Micro Optical has developed specific software to run on their hardware displays and this software is capable of accepting the inputs from the present invention finger transmitters on each finger if it was necessary to manipulate in 3D an object in the display or certain computing and printed text along with the display was required by the end user.

One advantage of Heads up Displays is that a user can go about his or her day with relevant computer information constantly in their periphery via the heads-up-displays, such as email, stocks, news, weather, music, etc. and then interact with the system as needed. For example, when an email comes into a user's computing device's inbox, a user sees the subject matter and name of sender out of the corner of his eye on a heads-up display as mentioned above. However, unlike the attention needed to look at a small handheld PDA screen to check new information, heads up display information is no more distracting than a billboard on the side of the road—it is there for a glance in the periphery but not distracting from the primary field of vision. Because a preferred embodiment of the present invention is such that transmitters are worn at all times, the user could access the email with just a wave of his hand or some other sensed motion of the body. The user could then drag the email from his peripheral vision into his central vision, read the email and then respond, all through a series of hand motions and finger manipulations, which are interpreted by the firmware, hardware and/or software programs of the computer system. With the present invention users are freed from their desks and allowed to efficiently interact with their computer applications and functions on the fly. The improved mobility allowed by the present invention is important in the fast pace business world where information is critical, such as runners in the trading pits on Chicago's Board of Trade for example, but it is also useful for personal tasks, such as chatting with friends via Instant Messages.

The present invention's flexibility allows application and system designers to create as simple or complex an interactive computing system as they desire using as many or few transmitters as needed to accomplish a desired result. One advantage of the present invention is the new visual environments software developers can employ. Although there are some applications which employ a three dimensional environment, they are generally limited in user base because most personal computers operate on a two dimensional environment (e.g. computer desktop) as analogous to a physical desktop. However, if heads-up displays are utilized in conjunction with the present invention users can interact with a more real-world familiar three dimensional environment because the transmitters and their corresponding attachment points can move in three dimensions. For example, if a developer designs software which uses the present invention method to employ the index finger of a user's hand as a mouse, that mouse can be moved left, right, up and down just as a traditional mouse can, but it can also be moved forward and backwards. Consequently, users can have an “immersive” experience in their computing environment.

Video games, which allow users to experience the game in first person, are increasingly popular. However, most of these video games lack some reality because the user generally controls the game via a mouse and keyboard or game controller. Even new game systems, such as the Sony Playstation 3 and the Nintendo W ii, which incorporate transmitters, do so as part of the hand-held controls. The present invention would allow users to attach transmitters to key points on their body so that the game software could simulate the motion of the user's body. He could literally jump, duck, run, shoot, punch, or perform any other action that he desires his virtual game character to perform. The corresponding motions of the transmitters on the user's body would be interpreted by the computing system and the game character would perform the same action as the user. This would allow the game experience to achieve new levels of interactivity for the end user that was not possible, or cost effective, before with the traditional input devices and systems of the past.

Additionally, the present invention allows users to interact with traditional computers in a more ergonomically positive way. Traditional keyboard, mouse computer inputs, even those specifically designed to be ergonomic, force the body to be relatively hunched over the computer. With transmitters attached to a user's fingers and hand/finger manipulations to generate the desired text and mouse inputs, the user would be able to sit more comfortably with his hands in a relaxed position, such as on the arm rests, in the user's lap, hanging at the user's sides, or whatever position is comfortable. In this embodiment the virtual input device would simply replace the traditional keyboard and mouse of a common computer system and provide for a more ergonomic and effective computing method.

Further, in accordance with the present invention, a virtual input apparatus for a computing system that uses body or object manipulations by an end user to generate data or command signals for a human machine interface to control a host of various devices activated by said data or command signals, includes a transmitter(s) located on the body of an end user having a signal output; a receiver for picking up said signal output; electronics connected to the receiver for converting the signal output into raw spatial data representative of the movement of the transmitter(s) during the body or object manipulations; and a program run on said electronics to process the raw spatial data into a predetermined interpreted command format for operating a selected device.

Yet another aspect of the present invention includes a method for generating operating commands to a machine from a virtual input apparatus by body or object manipulations, comprising the steps of: attaching at least two or more transmitters at various locations on a body (or object manipulated by the end user); sensing the manipulation of the transmitters on the body (or object) with respect to each other or to a spatial point as the end user creates a motion of the attached transmitters to generate a signal output; receiving and translating the signal output into raw spatial data from the body (and object) manipulations from the end user; feeding the raw spatial data into a command interpreter to provide control signals that can be read by the machine; delivering the control signals to the machine.

Other aspects of the present invention will become apparent in view of the following drawings taken in conjunction with the following description but this invention is capable of being modified in certain aspects which are still in keeping with the invention as shown.

### BRIEF DESCRIPTION OF THE DRAWINGS

FIG. 1 is an overall schematic drawing of a hand showing a virtual input device and system for a computing network used in connection with the present inventions;

FIG. 1A is a schematic drawing of a transmitter, receivers and processor in accordance with the virtual input device and system of present inventions as shown in FIG. 1;

FIG. 2 is a schematic drawing of a hand, transmitters, receiver and block diagram of program defining a spatial translation of the fingers in accordance with the invention of FIG. 1;

FIG. 3 is a schematic of a pair of hands wherein the spatial relationship between the fingers is shown diagrammatically in accordance with the present invention of FIG. 1;

FIG. 4 shows a pair of hands with the movement of the fingers sensed in accordance with the invention of FIG. 1;

FIG. 4A show a pair of hands with the movement of its fingers sensed in yet another spatial relationship in accordance with the invention of FIG. 2;

FIG. 5 shows transmitters located on the fingertips and along the arm in accordance with the invention of FIG. 1;

FIG. 5A shows a hand with fingertip transmitters and an implement with transmitters held and manipulated within the grasp of the hand in accordance with the invention of FIG. 1;

FIG. 6 shows a hand with transmitters on the fingertips and other locations on the hand in accordance with the invention of FIG. 1;

FIG. 6A shows band transmitters attached around the fingers and wrist of a hand in accordance with the invention of FIG. 1;

FIG. 6B shows a ring and bracelet transmitters attached to a finger and wrist in accordance with the invention of FIG. 1;

FIG. 7 shows a peer-to-peer network between two users inputting signals into a device in accordance with the present invention of FIG. 1;

FIG. 8 shows two users via a local area network controlling a device while a remote user through a network interface and the Internet is connected to the same local area network to control the device in accordance with the present invention;

FIG. 9 shows a user with transmitters on the hand able to connect to a host of different devices in accordance with the invention of FIG. 1;

FIG. 10 shows yet another fingertip transmitter arrangement showing spatial relationship between the fingers on a hand in accordance with the present invention of FIG. 1;

FIG. 11 shows a hand with transmitters on fingertips in two different positions in which the positioning distance between the two different positions is measured in accordance with the present invention;

FIG. 12A shows a user with the transmitters sending signals to the receiver located on the device to be controlled in accordance with the present invention;

FIG. 12B shows a user with transmitters that send signals to intermediate processors located on the user and collected at one processor for transmission to the device in accordance with the present invention; and

FIG. 12C shows a user with transmitters on his hand that transmit to a stand-alone processor which in turn sends the control signals a computer via wired or wireless connection in accordance with the present invention.

### DETAILED DESCRIPTION

While this invention is capable of several embodiments in many different forms, there is shown in the drawings and will herein be described preferred embodiments of the invention with the understanding that the present disclosure is to be considered as an exemplification of the principles of the invention and is not intended to limit the broad aspect of the invention to the embodiments illustrated.

The present invention is generally related to a virtual input device for personal computing which is capable of inputting data and/or commands to control the functions and operation in a host of computing devices currently being sold to the public. The data and/or commands are entered via a network or a direct input of signals representing the keystrokes of a keyboard, a mouse, and movements in a video game, a joystick for video games or simply the typical manual controls on the device to be controlled. With the advent of miniaturization, nearly all electronic devices that provide a source for digital multimedia, audio, video, audio/visual, such as podcasts, news, sports, comedy, pop-culture, technology, music, and more, are becoming more mobile and virtual devices. These mobile electronic devices require new ways to enter data and control commands into them.

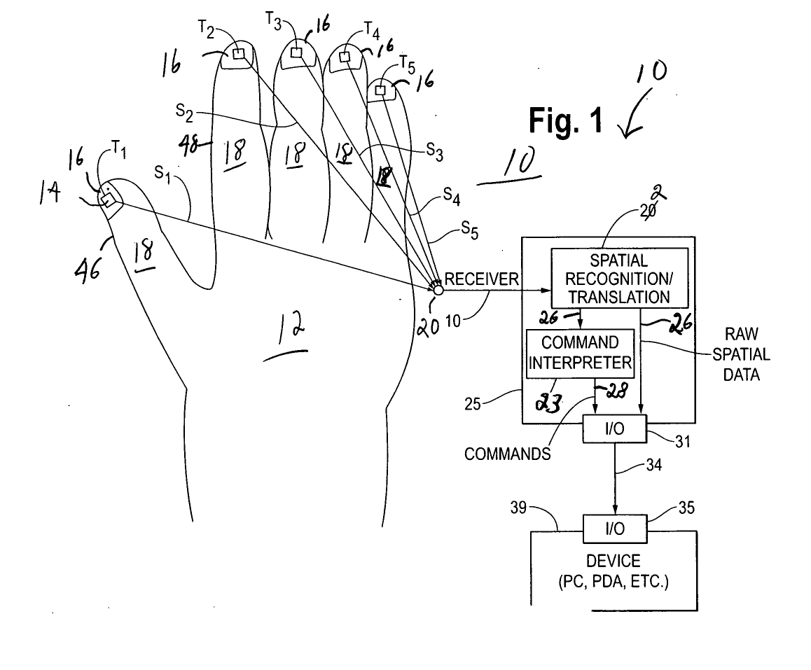

Turning now to FIG. 1, a preferred embodiment of the present invention is a virtual input device, generally designated 10. In this embodiment, a human hand 12 is shown that includes disposable, removable or temporary transmitters 14, represented by symbols T1 through T5, which are affixed or attached to a user's fingernails 16 on each finger or digit 18. Each transmitter 14 emits a unique signal such as Radio Frequency (“RF”) signal or a microwave (“MW”) signal, represented by output signal lines S1 through S5. Each RF output signal is received by a receiver 20 (or collective of receivers shown by R1, R2, R3 in FIG. 1A each sensing an output signal S from transmitter 14), which are collectively displayed throughout this invention description as a single receiver(s) 20, which in turn is connected to further electronics that includes a processor or microprocessor and associated memory circuits represented by block 25. The typical memory circuits used with microprocessors include EPROM, EEPROM or Flash Memory with programming represented by spatial recognition/translation and command interpreter logic blocks 22 and 23, respectively. The RF/MW signals S1-S5 are interpreted by a spatial recognition logic block 22 (similar to that shown in U.S. Pat. Nos. 6,515,669 and 6,943,665 and incorporated herein by reference thereto), which then determines the spatial location of each transmitter 14 with respective to each other to provide spatial data via line 26 to the command interpreter logic block 23 to be described in more detail later.

The present invention utilizes the physical characteristics of the human hand 12, and its natural spatial features between its digits 18 as a source or basis for creating spatially related signals relative to the position or orientation of the digits 18 with respect to each other and to an external sensing point 20, i.e., the receiver(s) R1-R3 of FIG. 1A. The raw spatial data 26 is then fed to the Command Interpreter logic block 23 where the spatial data is transformed into various control or command signals 28 for a personal computer, PDA, Video Game or other computing electronic device(s) 39, which is desired to be controlled. The command or control signals 28 are then transferred to an input/output (I/O) interface 31 on the processor 25 to transmit the command or control signals 28 information via a wired or wireless connection 34 to an input/output (I/O) 35 of the electronic device(s) 39 in which the end user wishes to use the spatial relationship between the digits 18 on the users hand 12 to create data resulting in the pre-determined commands 28 used to control the electronic device 39.

The electronic device 39 can be a PC, a PDA, an iPod®, or a host of other electronic device(s) 39 that the end user intends to control in some fashion. Additionally the invention can be set up for pre-defined spatial locations between digits 18 to be translated to pre-defined commands by logic blocks 22 and 23, respectively. For example, a certain spatial location of two fingers 18 relative to one another might be pre-defined to indicate the letter character “b” on a keyboard. Any pre-defined command or control signals 28 interpreted by the logic block 23 are transferred to the I/O interface 31.

In the event, the electronic device(s) 39 includes a command interpreter 23 that is built into the electronic device(s) 39, then the raw spatial data 26 from the spatial recognition and translation logic block 22 is fed directly to the processor I/O 31 for transmission to the I/O 35 of the electronic device(s) 39. Over a period of years in use, the raw spatial data and its resulting command signals may become a standardized format and every electronic device(s) 39 will be able to interpret the raw spatial data associated with certain transmitter manipulations within its microprocessor and transform the spatial data 26 into the same command or control signals 28 in a similar fashion for its own purposes of controlling the electronic device(s) 39.

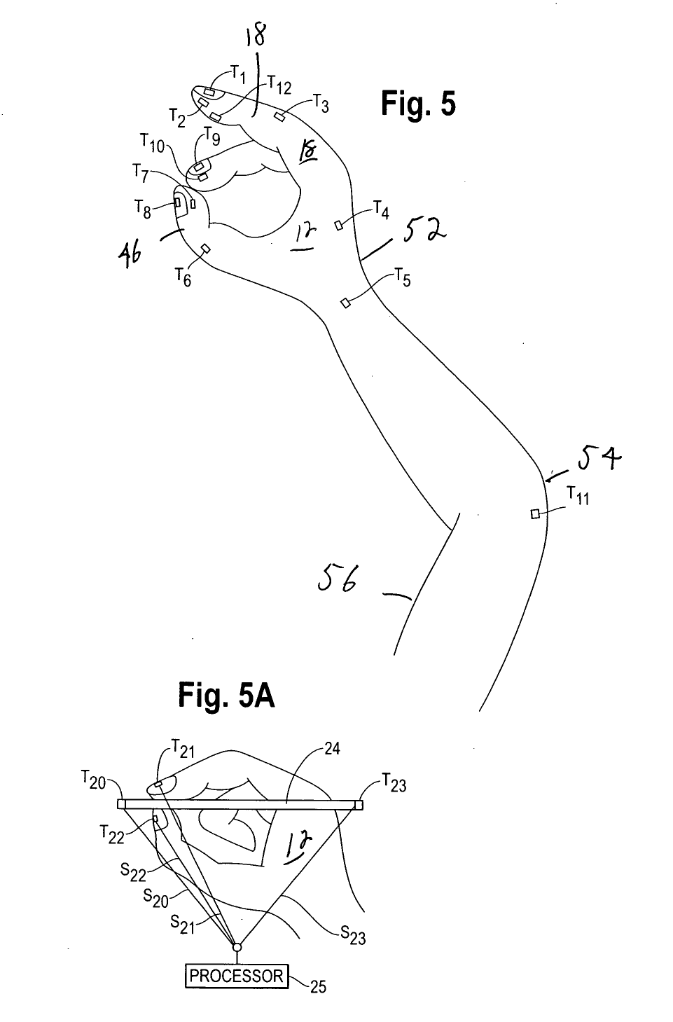

Additional transmitter(s) 14 are located at other points on the hand 12 or body of the end user to provide expanded sensory inputs as displayed in FIG. 5 and discussed in more detail later to cover most of the letters, characters, symbols, or numbers on a keyboard or to control a mouse for example. The transmitter(s) 14 are generally placed on the fingernails of a hand to provide a maximum of different possible combinations of command or control signals 28 along with whatever other combination of transmitter(s) 14 that are located on other body parts or articles of clothing to interact with one or more of the transmitter(s) 14 affixed to the fingernails 16 on a hand 12.

The transmitter(s) 14 located on the various body parts provided output signals S that are translated into raw spatial data 26 and later converted into the resulting command or control signals 28. The control signals 28 are transferred from the I/O interface 31 via a wired or a wireless communication method (described in more detail above and below) 34 to the I/O interface 35 of the electronic device(s) 39. The electronic device(s) 39 could be a mainframe computer, desktop or laptop computer, a PDA, a cell phone, a stereo or some other audio/visual component or device, or any other electronic device or computing device, collectively referred to as “electronic device(s) 39” hereinafter.

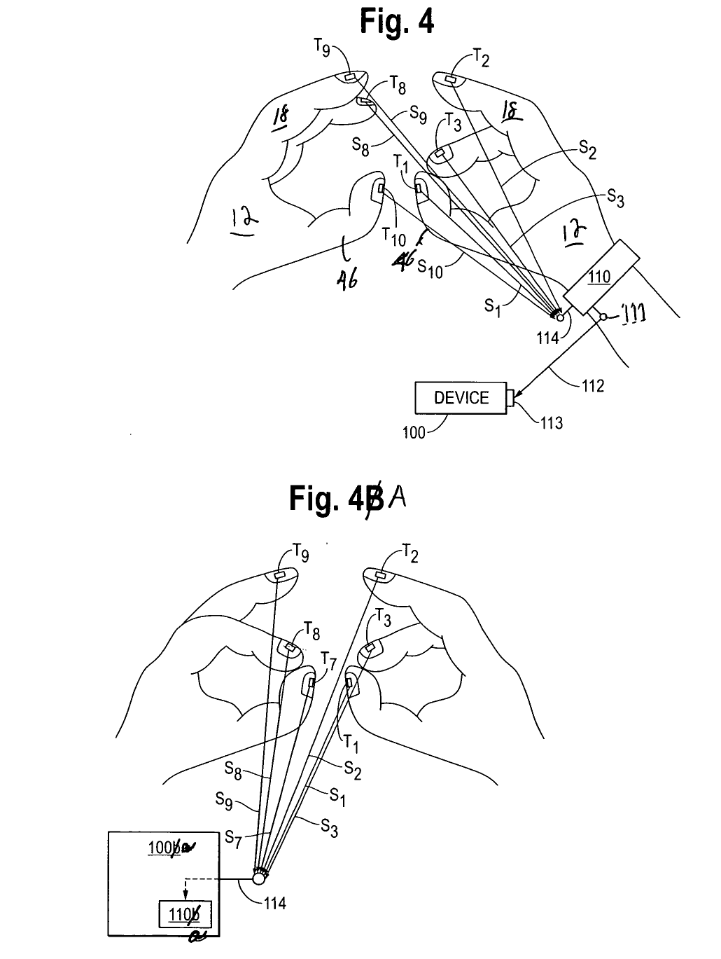

The processor or microprocessor 25 and electronic device(s) 39 with their I/O ports 31 and 35, respectively, can interface by any known communications protocol or method now shown or known or hereafter known, which may include, but is not limited to, infrared, optical, USB, Serial, Parallel, Ethernet, FireWire, Bluetooth, Wi-Fi, cellular, satellite, or other applicable communication methods that can be used to interface raw spatial data 26, which is then converted into predetermined command or control signals 28 to operate the electronic device(s) 39. Also, as described in FIGS. 4 and 4A, microprocessors 110 and 110a, respectively, are separately located on the end user or embedded within electronic device(s) 100 and 100a, respectively, such that the device(s) 110 and 110a have receiver(s) 114 that receive Electromagnetic output signals (e.g. RF, MW) from the transmitter(s) 14 and relays those to the separate or embedded processors, 110 and 110a, respectively, which then interprets the raw spatial data signals 28 as indicated herein and communicates with the device(s) 100 and 100a via I/O 111 externally and preferably wireless RF/MW communications connection 112 carrying the command or control signals 28 to an I/O 113 of the electronic device(s) 100 or communicates directly the control signals 28 internally through the embedded microprocessor 110a to the electronic device(s) 100a, respectively.

Referring back to FIGS. 1-4, the electronic device(s) 39 interface within the present invention via one of the previously described I/O wired or wireless communication methods 34 and 112 that are designed to utilize the raw spatial signals 26 and/or the predetermined command or control signals 28 corresponding to pre-defined raw spatial data defined by the transmitter(s) 14 locations on the end user's body to accomplish any desired goal of the particular developer of the electronic device(s) 39, 100 and 100a to be controlled. Here are just a few examples, which are meant to demonstrate uses of the present invention and how they may interface with various electronic device(s) 39, 100 and 100a for certain desired control functions. However, these examples below do not in any way limit the scope of the present invention, which are better defined by the claims herein.

In example 1, a computer company interfaces with a personal computer such that finger or digit locations of the end user can be used to enter letters, numbers, and other symbols or commands instead of using a computer keyboard with a mouse. In addition, predefined motion patterns of a particular finger could be used instead of a computer mouse. The particular finger 18 and its predefined motion could be used to indicate a “click” or selection as is common with a typical computer mouse application. The electronic device(s) 39 could be used to interpret the raw spatial data signals 26 output from the spatial recognition/translation logic block 22 representing the transmitter(s) 14 manipulations and to transform the raw spatial data signals 26 into the desired data or command or control signals 28 when the microprocessor 25 is embedded within the electronic device(s) 110a. Or the electronic device(s) 39, 100 and 100a are all configured with pre-defined commands for many of the desired command and control signals 28 so that the microprocessor 25 feeds only raw spatial data or data signals 26 directly into the electronic device(s) 39, 100 and 100a whether or not the microprocessor is separate or embedded with the electronic device(s) 39, 100 and 100a.

In example 2, a medical systems company incorporates the novel virtual input device 10 into the control of a medical system, which may include a video display of a guided camera and/or even an operating instrument as later described in FIGS. 5 and 5a herein. But in general, the spatial motions of a surgeon's hand 12 (and thereby the motions of the attached transmitter(s) 14) allow a surgeon to control a virtual organ or a remote, computerized scalpel by displaying both on the surgical video screen during a demonstration or actual operation. The video display showing the movement of the computerized, remote scalpel during an operation is an LCD, Plasma, heads-up-display, or other compatible computer screen or display, showing the surgeon how to the guide the microscopic surgeon tools that are now used in many laser surgeries today.

Another advantage of the present invention is the attached transmitter(s) 14 are discrete, and therefore disposable units, especially, the passive transmitter film and the active transmitters from chips or isotopes, that can be worn at all times and under a surgeon's gloves without any mobility problems or interference with the surgeon's hands during an operation on a patient.

Thus, during a surgical procedure, a doctor controls the laser surgical tool by showing and controlling its movement on the computer display system to record and show the operation to others without any physical contact with a computer terminal or other input hardware for the medical display system, thereby preserving sterility during the operation while recording the procedures for educational and other purposes. In addition, the doctor can use natural motions, such as grabbing and rotating and moving his hands to control any virtual computer objects or actual organs on the video displays. The software programs are able to interpret these motions of the surgeon's hands with the transmitters 14 affixed to the fingers of the surgeon's hands. The spatial motions of the surgeon's hands are processed by the software or firmware of the medical system in keeping with pre-defined command or control signals in the software for many of the desired inputs and outputs required to run the surgical programs.

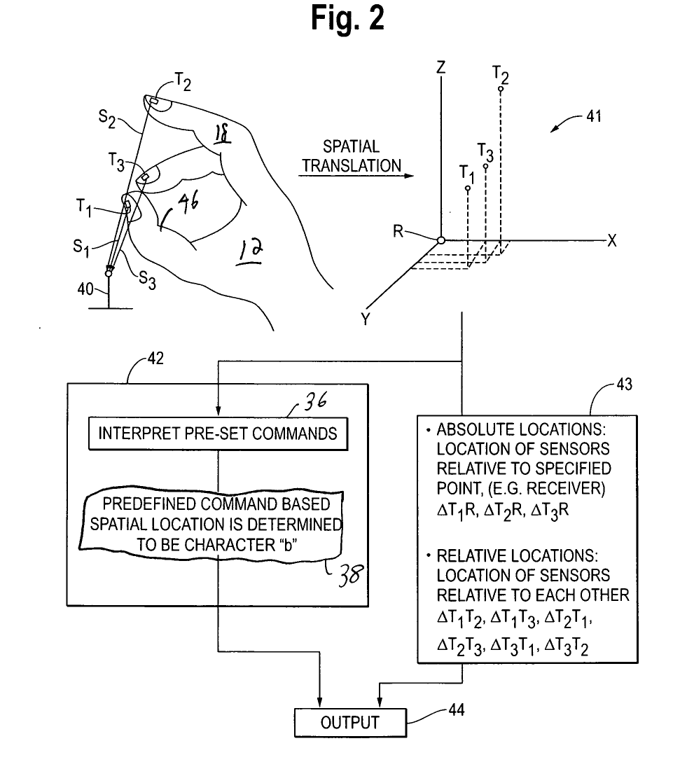

Returning now to FIG. 2, in addition to the hand 12 and three of the digits 18 with three transmitters T1-T3 affixed thereto having output signals S1-S3, respectively. S1-S3 are picked up by a receiver 40, a three-dimensional graph 41 describes the translation of transmitter signals (T1-T3) into spatial relationships relative each other and to the receiver 40. In this embodiment, the transmitters T1, T2, T3 are attached to three fingers 18 of a user's hand 12. The transmitter(s) T1-T3 send output signals shown by lines S1, S2, S3, to a receiver 40 (corresponding to the numeral 20 in FIG. 1). As shown in FIG. 1, the spatial recognition and translation logic block 22 translates the output signals S1-S3 of the transmitter(s) S1-S3 into their raw spatial data locations with respect to each other and with respect to the receiver 40 as shown in the three dimensional graph 41 in FIG. 2. In this graph 41, the spatial location of the three sensors or transmitter(s) T1, T2, T3, is shown relative to the receiver R 40 at the connection point R of axes X, Y, and Z. Once the three dimensional location of the sensors are known relative to the receiver 40 and relative to the location of each transmitter(s) 14 with respect to each other then the corresponding command and control signals can be determined.

Referring now again to FIG. 2, the absolute locations of transmitter(s) T1-T3 relative to specified point R (e.g. receiver 40) or relative location of transmitter(s) T1-T3 to each other are transferred to an output 44 (corresponding to I/O 31 in FIG. 1.). The raw spatial data 26 from the spatial recognition translation logic block 22 in FIG. 1 transmits this information as shown by block 43, which includes the absolute transmitter locations (?T1R, ?T2R, ?T3R) and the relative transmitter locations (?T1T2, ?T1T3, ?T2T1, ?T2T3, ?T3T1, ?T3T2) where ?T1R refers to the three dimensional distance between points T1 and the Receiver and ?T1T2 refers to the three dimensional distance between points T1 and T2. For ease of understanding only three transmitter points T1, T2, T3 are shown in FIG. 2, however the present invention allows for essentially an unlimited number of transmitter points.

As described in FIG. 2, in addition to the raw spatial locations 43 of the transmitters or sensors T1-T3, the present invention can be configured to determine pre-defined commands from the raw spatial data 26 in a interpret pre-set commands logic block 36 including a predefined command base spatial location logic block 38 for forming alpha letters such as the character “b” for example in which blocks 36 and 38 are subsets of a logic block 42 (or logic block 23 in FIG. 1). In FIG. 2, the logic block 42 determines that spatial locations of transmitters T1 through T3 and the logic determines if the digits 18 are sufficiently close enough to indicate a thumb 46 and index finger 48 are touching one another, which for instance corresponds to a pre-defined command for the letter “b”. Therefore, in addition to the raw spatial data 26 being sent from logic block 43 to the output 44 (or 31 in FIG. 1) of the microprocessor 25, the command letter “b” data is also sent to the output 44. The transmitter(s) T1-T3 are capable of being affixed on any part of the body including the placing or affixing of the transmitter(s) to articles of clothing whereby the transmitter(s) T1-T3 are disposable, relocatable and replaceable to create new predetermined patterns of motion corresponding to new command or control signals for the electronic device(s) 39.

The microprocessor is configured to output via I/O 44 raw spatial data 26 as symbolized within logic block 43 to provide the three dimensional location of the sensors T1-T3 relative to the receiver 40 and to each other and to provide interpreted command or control signals 28 represented by logic block 42. The spatial translation graph as shown in FIG. 2 represents those spatial relationships between transmitters T1-T3 on the x, y and z axis of the graphical representation 41 thereof. The microprocessor 25 with a simple change to its instruction is configurable to output only raw spatial data 26 as represented by logic block 43 or to output only interpreted pre-set commands 28 as represented by logic block 42. Additionally, the electronic device(s) 39, which interface with the virtual output device 10, are easily designed to accept either the raw spatial data 26 from the transmitter(s) T1-T3 or the results of the interpreted and predetermined pre-set commands 28 and to disregard any unneeded data.

Pre-determined commands are not limited to transmitter(s) 14 locations such as shown by transmitter(s) T1 and T3 in FIG. 2. Pre-defined commands could include many more transmitter(s) 14 and many different complex movements of the transmitter(s) 14 through a number of spatial patterns as the end user moves the hand 12 with its fingers 18 or other members of the body having transmitter(s) 14 strategically located thereon to create the desired command or control signals 28 to operate the electronic device(s) 39.

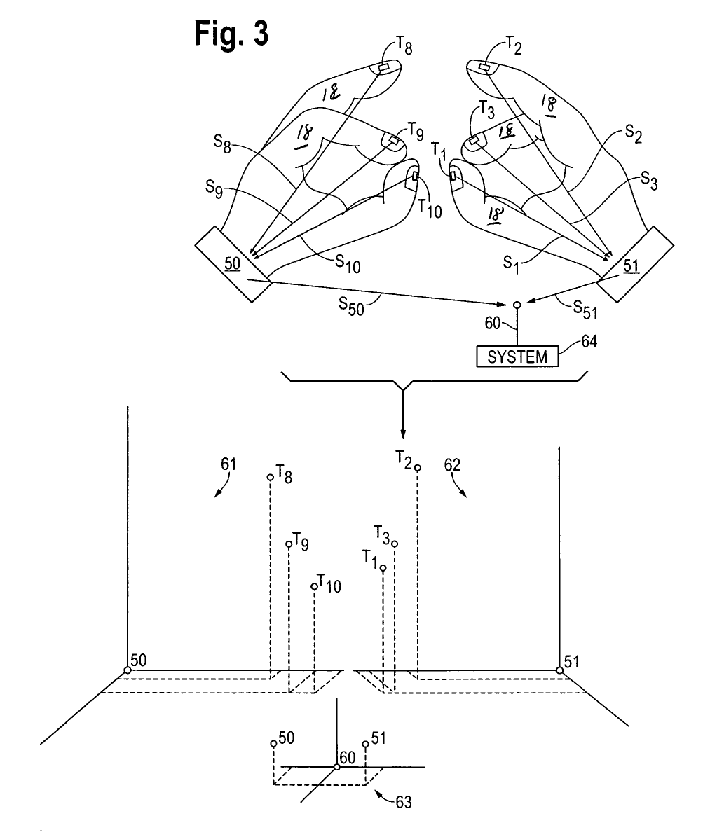

For example, the user could make a fist and then make a punching motion with the fist to activate on a specific program such as an interface with a video game. Or, a particular hand or body motion with the transmitter(s) 14 thereon, could trigger a host of different programs such as a complex sign language for the deaf or other set of software programs having a specific motion of the hand or body to actuate the setup of the program to run on the microprocessor 25 and then to be play or interface with the specific program by the control signal inputs corresponding to a specific set of finger and body movements or manipulations of the fingers with transmitter(s) 14 in strategic locations on the hands, legs and other body parts of the end user. Another unique factor of the present invention allows for any motion of affixed or attached transmitter(s) 14 to indicate a pre-defined command or program that runs the particular or predetermined electronic device(s) 39. For example, rapidly moving an open hand from left to right might signify “delete”, where as other hand motions might signify, “open”, “move”, etc. Quite often, disposable and passive transmitter(s) 14 are worn permanently on the fingernails 16 of at least one hand or both hands. The passive transmitter(s) 14 often produce a very low level RF/MW output signal. Such low level output signals S1-S3 and S8-S10 used with a receiver 60 in a computing system 64 located some distance from the end user with the transmitter(s) T1-T3 and T8-T10 on the fingers 18 are often too far away to be picked up by the receiver 60 as shown in FIG. 3. The distance between the transmitter(s) T1-T3 and T8-T10 and the system 64 precludes a proper transmission and reception of the output signals from the transmitter(s) T1-T3 and T8-T10, especially in a wireless communication mode. FIG. 3 also demonstrates how a pair of intermediate processors 50 and 51, respectively, is useful in picking up those faint signals S1-S3 and S8-S10 from these low level signal transmitter(s) T1-T3 and T8-T10. The intermediate processors 50 and 51 easily pick up the low-level output signals S1-S3 and S8-S10 to determine the locations of the transmitters relative to the intermediate and then broadcast those relative locations as well as a transmitter signal to the receiver. The receiver then knows the location of the intermediate processors and the locations of the transmitters relative to the intermediate processors as well as extrapolating the location of the transmitters relative to the receiver itself. Therefore, the intermediate processors 50 and 51 function as a relay to relay those locations to the receiver of system 64 for further processing and determination of the spatial relationships of transmitter(s) T1-T3 and T8-T10 on the fingernails 16. As shown in FIG. 3, there are three transmitters T1, T2, T3, attached to three fingers of one hand 12 and three transmitters T8, T9, T10 attached to three fingers of another hand 13. In FIG. 1, the receiver 20 receives the generated output signals S1-S5 from all sensors T1-T5 independently of any other circuitry. In the embodiment of FIG. 3, the pair of intermediate processors 50 and 51 is used to receive the output signals generated by transmitter(s) T8-T10 and T1-T3, respectively.

As shown in this FIG. 3, the intermediate processors 50 and 51 are shown as being incorporated into bracelets or watches that are worn on each wrist of the opposing hands. However, an intermediate processor can be located anywhere on or off an end user's body but generally in sufficient proximity thereto to pickup the low level output signals from active or passive transmitter(s) affixed or located on the fingernails 16 of the hand. Passive transmitters suitable for use are made by manufacturers like Zebra Technologies in Vernon Hills, Ill. or Appleton Paper, in Kaukauna, Wis. Since the overall dimensions of the passive transmitter footprint is extremely small and thin, the passive transmitter may be worn underneath fingernail polish for a protective coating from the elements of daily wear in which the hands will be washed or receive exposure to the outdoor weather conditions. Moreover, this embodiment of the present invention is not limited to just two intermediate processors as other maybe used in concert to relay the output signals to the appropriate final computing system to transform the output signals of the active or passive transmitter(s) 14 into the raw spatial data for interpretation and conversion into command or control input signals into various electronic device(s) 39 that are benefited by the virtual input system of the present invention.

Turning now to FIG. 3, the intermediate processor 50 receives the signals S8-S10 from transmitters T8, T9, T10 and then generates a composite signal S50, which in turn is sent to the receiver 60 of the predetermined computing system 64 to determine the spatial locations of the transmitter(s) T8-T10 relative to the intermediate processor 50 as shown in a graph 61. The composite signal S50 then transmits the results of those spatial relationships through a wired or wireless signal S50 to the receiver 60 of the computing system 64. Similarly, the intermediate processor 51 processes a composite signal S51 from transmitters T1, T2, T3 to determine the spatial locations of the transmitters relative to the intermediate processor 51 as shown in a graph 62. The composite signal S51 transmits the results through a wired or wireless connection to the same receiver 60 of the computing system 64. The receiver 60 of the computing system 64 receives the spatial locations of each intermediate processor(s) 50 and 51, respectively. The computing system 64 (or the computing system or processor 25 in FIG. 1.) processes those signals that are then used to control the operation of the particular electronic device(s) 39. By determining the spatial locations of intermediate processors 50 and 51 and the spatial locations of transmitters T1, T2, T3 relative to T8, T9, T10 relative to processors 50 and 51, the computing system 64 is able to determine the spatial location of all six transmitters and the intermediate processors relative to the receiver 60 and relative to each other as shown in diagrams 61, 62 and 63 of FIG. 3.

As needed by the particular electronic device(s) 39, which are controlled by the finger positioning to generate the commands thereto, the embodiment of the present invention as shown in the diagrams in FIGS. 2 and 3, the processor(s) 25, 50 and 51 provide output signals that represent the relative position of any transmitter(s) 14 at any given time or any intermediate processor(s) 50 and 51, respectively, relative to each or the absolute location of any transmitter 14 or intermediate processor 50 or 51 relative to a single point such as the receiver 60 of computing system 64. In addition, the computing system 64 could interpret predefined commands from the raw spatial locations and motions of sensors T1-T3 and T8-T10 and intermediate processors 51 and 55, respectively.

Intermediate processors are useful to more accurately determine the spatial location of transmitters because the receiver in the intermediate processor can be located closer to the transmitters and pick up the signals better especially if the signals generated by the finger motion are produced by a low level, passive and film type RFID circuit with extremely low power output. This is especially useful if subtle changes in relative location of the fingers are needed for the production of various command signals to operate the electronic device(s) 39.

Referring now to FIG. 4, it demonstrates yet another embodiment of the present invention, in which a single processor 110 (or 25 in FIG. 1) is worn on the wrist of the hand 12. The processor 110 could be built into a stylish bracelet or watch as to be attractive accessory or jewelry on the end user. The transmitter(s) T1-T3 and T8-T10 are affixed to the fingernails 16 or implanted beneath the skin on the hands 12 of the end user. As previously described above in FIG. 1, the processor 110 receives the output signals S1-S3 and S8-S10 from any of the transmitters T1-T3 and T8-T10, respectively, and generates raw spatial data information 26 that is translated into specific commands or control signals 28 for operating electronic device(s) 39. Again, FIG. 4 depicts six transmitters T1, T2, T3, T8, T9, T10 generating signals S1, S2, S3, S8, S9, S10, respectively, which are then transmitted to a receiver 114 of the processor 110. As discussed in FIG. 1, the processor 110 determines the spatial location of the transmitter(s) T1-T3 and T8-T10 and any predetermined commands relevant to programming of the electronic device(s) 39. In this embodiment, the system then outputs the data or control commands 28 through an I/O 111 via a wireless communication line 112 to an I/O receiver 113 of a device 100, which includes the wireless I/O receiver 113 to enter data or control commands into the electronic device(s) 39. The wireless method of signal transmission may include Bluetooth, Wi-Fi, Infrared, or any other wireless communication protocol either known now or hereafter known in the future, as any wireless method of communication will always be adaptable to use with the virtual output device 10.

The embodiment as shown in FIG. 4 is one of the preferred embodiments because with transmitters or sensors 14 affixed to the fingertip 16 of the hand and the receiver and processor worn on the wrist as a bracelet or other piece of jewelry, the end user is able to interface with a multitude of enabled electronic device(s) 39 without having to first attach and then possibly calibrate any transmitter(s) 14 or processor(s) 25 when the end user needs to control or operate a particular electronic device(s) 39 if the occasion arises.

For example, if a user's car is equipped with a Bluetooth compatible radio, DVD player, XM satellite radio or embedded cell phone, which are all incorporated into the present car radio systems that interfaces with the virtual output device 10, a driver of the car is able to control the car's radio and other allied devices simply by various simple finger motions of the hand(s) without removing the hands from the steering wheel or ever having to reach and touch the car radio controls while the vehicle is moving in traffic. From a car safety and security standpoint, the combinations of transmitter(s) or a single transmitter providing output signals to the microprocessor, which can easily encode the control signals with a password that would match the password within the car radio computer (the electronic device) is highly desirable. Once the driver exits the vehicle and begins to walk away, the control signals will fade in a predetermined distance thereby disengaging the car stereo computer system, which in turn generates signals to lock the doors and ignition on the car after the user travels the predetermined distance from the vehicle. On the flipside, upon approaching the vehicle, control signals being outputted from the microprocessor on the end user unlock the driver car door and cause the ignition to start the vehicle by a simple manipulation of a digit or two with the transmitter(s) on those digits.

Later, as the driver leaves the proximity of the vehicle, the end user is able to activate a host of other above-mentioned electronic device(s) 39. The processor 110 (or 402 to be described later) awaits connection to another one of the electronic device(s) 39, such as a desktop computer when coming into close proximity thereto. Once the I/O circuit 111 of the processor 110 is within wireless range 112 of a particular computer device 100, it interfaces with the computer via the virtual input device 10 allowing that end user to control the functions of the computer. Again, a unique password for the computer or any other device is possible to be encoded into the Transmission(s) control signals 28 generated by the intermediate processor(s) 50 or 51 or processor(s) 25 for security purposes.

Safety is a major issue with drivers of vehicles today and the distraction of holding a cell phone up to ones ear and mouth to hear and speak is blamed for a number of accidents nationwide due to the distraction and fiddling that goes on with the use of cell phones while driving the vehicle. From a pure safety standpoint, the virtual input device of the present invention where the motion of a finger or two is manipulated while the rest of the hand or hands are securely on the steering wheel increases the overall safety of the driver engaged in a cell phone conversation. The voices in the cell call are then played through the cars radio speaker system without a cell phone being held by the driver's hand or even a worse scenario when the cell phone is scrunched in the all too familiar cradle between the shoulder and head while attempting to keep both hands on the steering wheel. Especially in the scrunched position between the head and shoulder, the cell phone often falls out of its cradle and then the driver is distracting while attempting to reach down and to retrieve the cell phone wherein the a driver might lose control of the vehicle causing an accident. Certain municipalities around the country have now passed laws forbidding the use of the cell phones held up to the head by the hand or scrunched between the head and shoulder while driving motor vehicles. The City of Chicago is a prime example of this law, which considers such cell phone use as a moving violation with an attendant heavy fine.

The present invention is also not restricted to the processor 110 being located on the wrist or even attached to the body at all. The present invention can be incorporated into any convenient article carried by the end user for implementation of the invention, such as but not limited to clothing and accessories like a belt, jacket, shirt, pants, hat, etc. However, whatever article is used to mount components of the system for implementation of the invention, it is desired that the article be one that is either carried on the end user person at all times or worn on the clothing or body so that the end user has the ability to implement the present invention at all times to interface with the various enabled electronic device(s) that the end user comes into contact throughout the day.

However there are instances when users would adorn or affix transmitters for specific tasks. For example, a doctor may wear certain transmitters or articles/clothes with embedded transmitters during the workday and then take them off before leaving work. Another advantage of the present invention is that when being worn, whether at all times or just part of the time, during that time the virtual input device does not interfere with the normal activities of the user and only contribute to the user's efficiency.

The potential security of encoded passwords or encryption, which the end user can preprogram into the processor, is a most desirable feature since whether it is a vehicle or computer in an office, the end user does not have to carry around a notebook or have passwords written down on a paper format posted around the desktop computer or laptop if ones memory fails to recall a particular password and then enter that password to begin interfacing with a desired electronic device Passwords written down and left near the electronic device to be controlled is a potential security breach especially in R&D facilities and corporate offices within businesses.

As demonstrated in FIG. 4A, components of the present invention can also be included as part of the enabled electronic device. For example, a PC, PDA, cell phone, digital music player, or any other device like a car radio with its onboard computer or processor (collectively shown as logic block 100a in FIG. 4A) includes an embedded microprocessor with the program features according to the present invention as part of the electronic device(s) 100a for accepting the control commands (shown as logic block 110a within the device 100a). In this instance a receiver 114 is built into the electronic device(s) 110a which receives the signals S1, S2, S3, S8, S9, S10 from transmitters T1, T2, T3, T8, T9, T10 and relays that signal to the processor 110a. The processor 110a transmits the spatial location and/or command data to the device 100a through an embedded I/O port 114 incorporated into the embedded processor 110a.

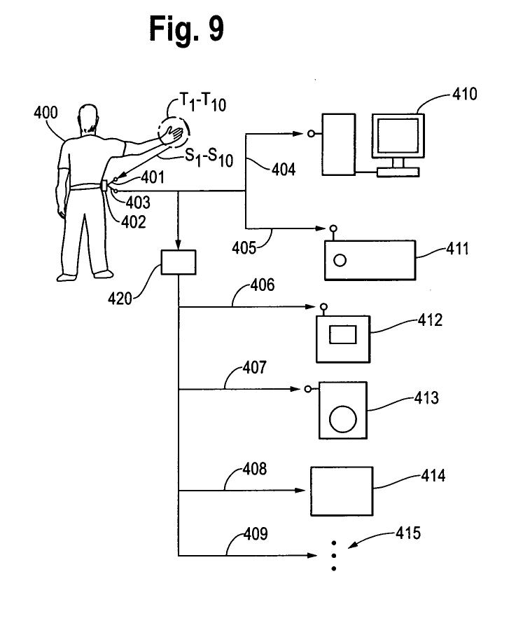

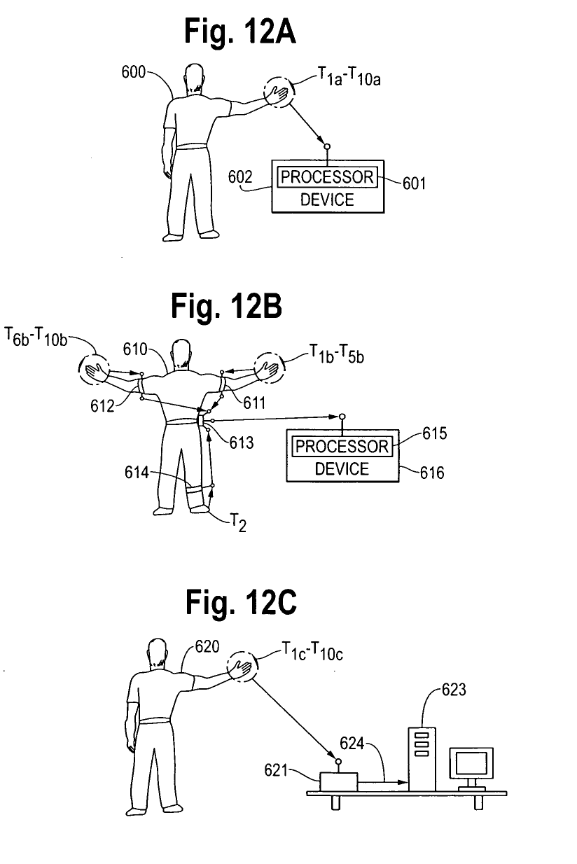

The present invention can also interface with multiple electronic device(s) 39 simultaneously or switch between devices easily (as shown in FIG. 9 and described in more detail later). As mentioned previously, transmitter(s) 14 can be affixed to any location on the body, such as the finger 18, a wrist 52, an elbow 54, an arm 56, a head 58, a torso 60, a leg 62, etc. as shown in FIGS. 5 and 12B. Additionally, multiple transmitter(s) 14 could be affixed to the same part of the body such as transmitters T1, T2, T3 and T12 attached to the same digit 18 of the hand 12 depicted in FIG. 5. The hand and arm of the end user contains transmitter(s) T1-T12 including T11 being located on the elbow of the end user. This configuration of multiple locations for transmitter(s) 14 on a finger, arm or leg could be used for better accuracy in determining the spatial position or manipulation of the finger, arm or leg relative to another finger, arm, leg or other transmitter or receiver. The present invention allows for application and device developers to use the present invention for any input method they desire, and therefore, must allow for as many sensors as those designers determine are needed to accomplish a desired user interface signal corresponding to particular indicia in a control program making the interpretation within the microprocessor of the virtual input device 10 or within the electronic device(s) 39.

Additionally, transmitter(s) 14 can be part of or attached to external articles like a wand 42 to assist in the implementation of the various finger motions to control a particular electronic device 39 as shown in FIG. 5a. FIG. 5a demonstrates the use of a wand 24 with two affixed transmitters T21 and T22 on the fingers 18 of the end user in addition to two transmitters T20 and T23 that are part of the wand implement 24. The processor 25 then interprets the generated signals S20, S21, S22, S23 from the manipulation of the wand 24 with respect to the hand 12 to determine the spatial location of the affixed transmitters and the wand transmitters to interface with an electronic device 39, which requires or must utilize these additional transmitters on the wand 24. For example, in this embodiment, a method is established for surgeons performing remote procedures whereby an implement like the wand 24 with transmitters T20 and T23 would simulate the position of a surgeon's scalpel or remote surgical device used during an operation. In the alternative, the wand 24 is an implement having a security code embedded in either or both of the transmitters T20 and T23 that is required to be present before a certain surgical device is operated such as a surgical laser machine or some heavy equipment is operated such as a truck or bulldozer.

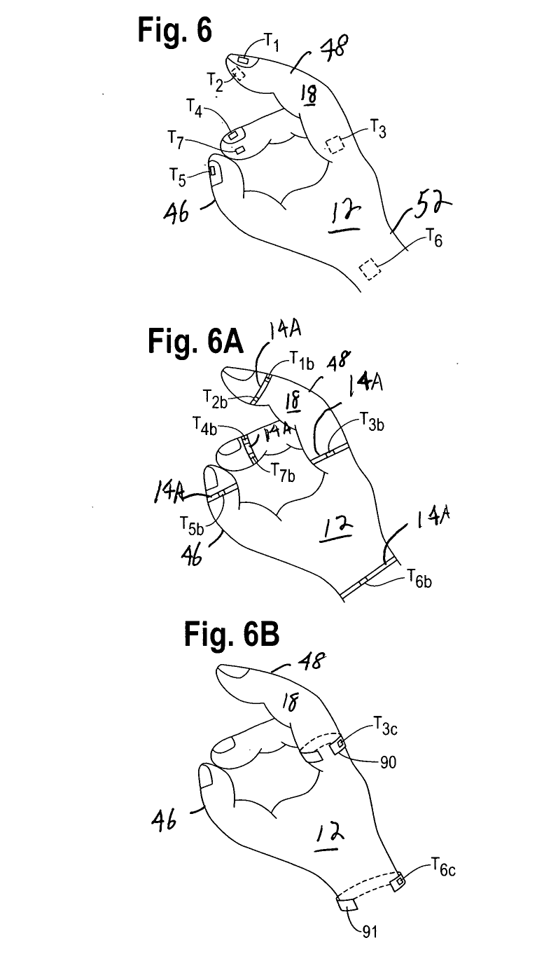

Another preferred embodiment of the present invention is where the transmitter(s) 14 are permanently or disposably affixed or attached to the user so that the transmitter(s) 14 are always present and available for interfacing with an active electronic device 39. As demonstrated in FIG. 6, the sensors or transmitters 14 could be attached to the surface of the skin or fingernail 16 by method of adhesion as depicted by transmitters T1, T4, T5, and T7. In one form, the virtual input data system utilizes inexpensive active or passive transmitters that are inexpensive, and therefore, easily and cost effectively replaceable if lost or damaged. In some situations like continuous broadcasting or video streaming, a passive transmitter is incapable of providing the requisite output signals to sustain such an operation. In a continuous broadcasting mode, the transmitters may incorporate thin-film battery or even solar cell power for the discrete, inexpensive transmitter in order to sustain the continuous broadcasting or streaming of video. In either configuration, a user could carry spare transmitters 14 in a wallet or a purse and then replace them as needed when they become lost or damaged for some reason. The typical cost of such transmitters is as low as a few cents for a passive transmitter or a few dollars for an active transmitter, both being relative inexpensive and easy to replace if damaged or lost. However, in some instances, it may be necessary for a more permanent or rugged attachment of the transmitters. One such option is to attach biologically safe transmitters 14 slightly below the surface of the skin as shown in FIG. 6 with the transmitters T2, T3, and T6, which are implanted just beneath the surface of the skin of the hand 12. These surgical implanted transmitters would not need to be replaced as often and would remain in place during more abusive or environmental challenging situations, such as in wet or cold conditions or where there is strenuous and abusive physical activity, such as in military or police work where the transmitters might otherwise become damaged.

In another embodiment, the transmitters 14 are incorporated into bands, which the user wears at the appropriate location on a chosen finger of the hand or around the wrist or body as shown in FIGS. 6A and 6B. The preferred embodiment of transmitter bands T1-T7 is a thin, discrete, clear rubberized band 14A with at least one or more transmitters embedded or attached to each band. Similar to the attachable transmitters 14 to fingernails 16 as described above, the transmitter bands 14A would be relatively inexpensive and easy to replace. If one was broken or lost the user could simply slip on another band 14A onto the finger, wrist or body. In addition, the band transmitters 14A allow a user to remove them if needed without having to waste or damage the transmitter. In FIG. 6A, each finger includes one or more transmitters T1b-T5b and T7b with a band 14A having the transmitter T6b around the wrist of the user. In FIG. 6B, the bands are placed on the finger by a split ring 90 with a transmitter T3c and a bracelet 91 with transmitter T6c. So the form of the band, ring or bracelet, with transmitters for the fingers and wrist can take on many different configurations during the implementation.

The present invention also allows users to network their systems and work collaboratively. For example, two users could work collaboratively on the same computer and its applications, a task made difficult by a single keyboard or mouse input to a computer shared by two people. Or one user could provide a set of commands related to specific motions of the finger 18, arm 56, hand 12 or leg 62, which would be transmitted directly from one user's computing system to another user's computing system or device.

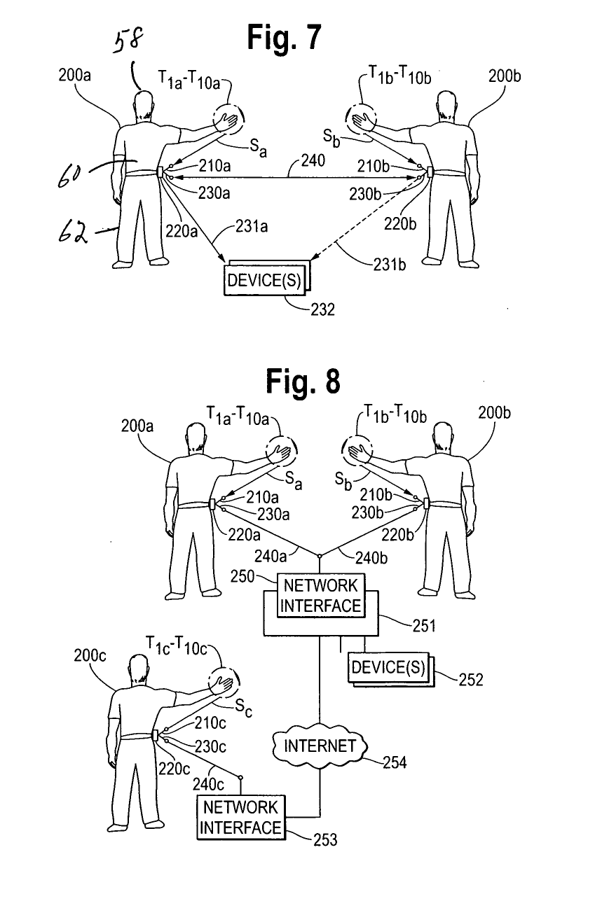

FIG. 7 demonstrates a peer-to-peer network between two users 200a and 200b, respectively, who can work collaboratively to interface with a device (or devices) 232. In this configuration, signals Sa generated by finger and hand motion manipulations from transmitters T1a-T10a of user 200a are received by a receiver 210a of processor 220a. Similarly, signals Sb generated by finger and hand motion from transmitters T1b-T10b of user 200b are received by receiver 210b of processor 230b. Processors 230a and 230b are networked together via a line 240. In this embodiment, the processor 230a communicates the collective inputs of processors 220a and 220b to the device(s) 232 via wired or wireless communication methods 231a.

The present invention also allows for multiple processors 220a and 220b to simultaneously communicate directly to the devices 232 via wired or wireless communication methods shown by solid line 231a and dotted line 231b.

FIG. 7 demonstrates a peer-to-peer network between two users; however, the present invention is not limited to one peer-to-peer network and may have any number of peer-to-peer connections that are collectively configured together by multiple end users.

Additionally, networked users can interface with each other and collaboratively interface with devices over a standard network as demonstrated in FIG. 8. In FIG. 8, three users 200a, 200b, and 200c are working collaboratively such that their respective processors 220a, 220b, and 220c can interface with each other via a complex network to operate device(s) 252 comprising a network interface or local area network 250 between the two users 200a and 200b, device(s) 252 are connected directly to a remote network 251 and user 200c connected via a network interface 253 to an Internet connection 254 to the remote network 251 controlling the device(s) 252. And all of the users collaboratively interface with devices 252 through their network interfaces 250 and 253 connected to the remote network 251, which in turn is connected to the device(s) 252 via the Internet 254 or a wired or wireless connection as shown for network 250.

Device(s) 252 are often machines, machine tools, overhead cranes in an industrial factory or yard setting, truck or dock loading machines, container loaders for ships and other machines used in industrial or commercial settings. When the user 200c is remotely located from the device(s) 252, then the end user typical has a video display available to view what is being done in real time over the Internet (or other network connection) to guide the operation of the machine in question and also to avoid an accidental operation of the machine, process or equipment.

The signals Sa, Sb and Sc for each transmitter(s) T1a-T10a, T1b-T10b and T1c-T10c, respectively are received by the users' 200a, 200b and 200c, respectively, by receiver(s) 210a, 210b and 210c and processed by each user's respective processor 220a, 220b and 220c and transmitted via wired or wireless output communication methods 230a-c to network interfaces 250 and 253 on the user's respective network. In FIG. 8, two of the users 200a and 200b are shown connected to the same local network 251 via LAN network interface 250. As demonstrated by user 200c, a user can connect to that same “remote” network 251 (remote relative to user 200c but local relative to users 200a and 200b) from another network interface 253 and/or over the Internet 254 and then interface with the device(s) 252 over the remote network 251.

One benefit of this network feature is that a computer or device is not required for each user in order for a user to interface with other users (whether peer-to-peer or over a network and/or Internet connection).

Another advantage of the present invention is that it can interface simultaneously with several devices or easily switch between devices. In other words, the network interface connection and communication method is often separate from the actual device being controlled, and therefore, it can be used to control or interface with many different devices with ease, local and/or remote. This virtual input device 10 capable of being networked is ideally suited for multi-player video games played over the Internet with opponents able to experience virtual reality type games with heads up displays and holograms. The game of chess comes to mind where each player could have his own pieces and move them on a hologram chessboard with the other player located across the country from the other player. Other multiple player games would allow you to log into a remote server running the game board and the end users control pieces on the game board via the remote interface connected to the server with the program.

FIG. 9 demonstrates a user interfacing with several electronic device(s) 39 simultaneously such as a desktop computer 410, a radio 411, a television 412, a car stereo system 413, a device with embedded processors 414 such as heavy machinery or equipment and a host of other compatible devices 415.

In FIG. 9, a user 400 has ten transmitters T1-T11 attached to his fingers, which transmit signals S1-S10 to a receiver 401 of a processor 402. The processor 402 interprets the signals as previously described above and outputs the resulting spatial signals at I/O 403 via wired or wireless communication methods 404, 405, 406, 407, 408, and 409 to a series of devices 410, 411, 412, 413, 414, or any number of devices represented collectively by 415. The present invention allows for the processor 402 to interface with several devices simultaneously or easily switch between devices. For example, a pre-defined position or motion of the user's hands, which is interpreted by the processor 402, could be used to switch between devices. In some cases, an intermediate signal processor or device 420 may be used to relay signals to devices via known wired or wireless communication methods such that the processor 402 does not necessarily have to communicate directly to the end device(s) 410 through 415. In addition, the intermediate signal processor can include a security check to make sure that the control signals are coming from an authorized operator whose microprocessor sending the control signal via its I/O is sending the proper password before the control signals from that end user are allowed to control the specific electronic device(s). So the intermediate signal processor 420 includes an internal electronic password checking system for reviewing the incoming control signals to make sure that the control signals are coming from an authorized source with the correct password before intermediate signal processor passes the control signals through to the controlled electronic device(s).

This above described password system is useful in large companies, which sometimes have thousands of employees in the same facility or campus with multiple buildings wherein certain desktop or laptop computers within the business contain R&D or other trade secrets or confidential business information that are kept secured by limiting the access to these computers via a password incorporated into the particular transmitter(s) output signals or microprocessor(s) control signals. Because the passwords are incorporated into either the transmitter or processor of the end user, there is no need to worry about passwords being left around an employee's workstation or someone else who happens to be in the building then watching the password being typed into the computer through a keyboard entry. The entry of the password is now transparent and invisible to fellow workers in the area. This provides added security to important military, government and other high tech businesses whose information must remain top secret for national security reasons.

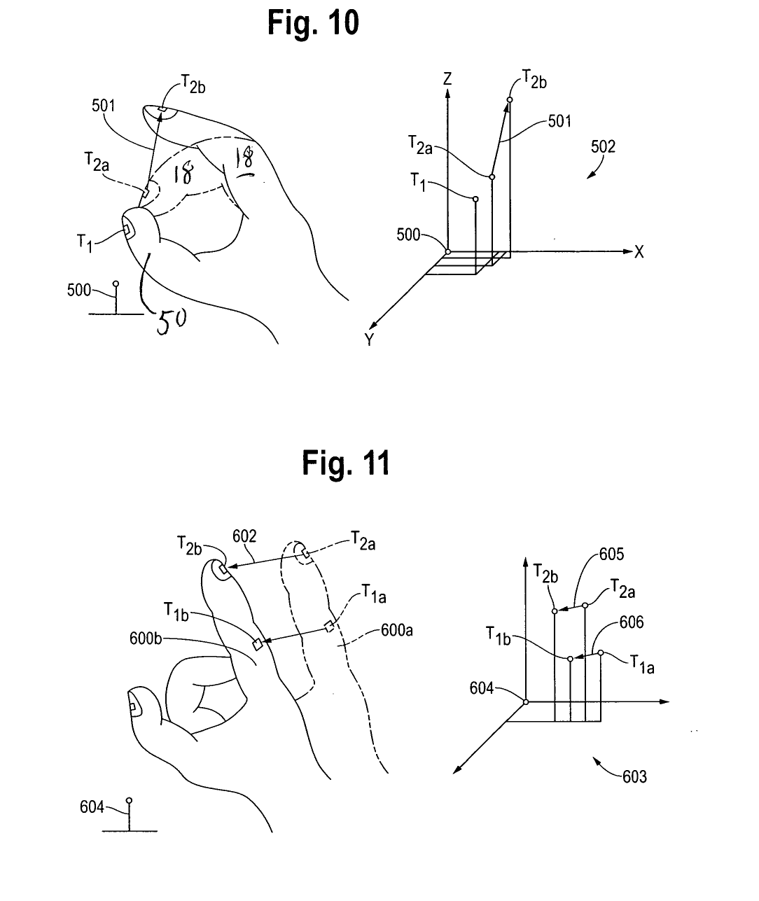

As demonstrated in FIGS. 10 and 11, the motion and positioning of the transmitter located on the fingers can be determined at any point in time. In FIG. 10, a transmitter T2a attached to a user's finger 18 is shown moving from a starting position (indicated by dashed outline of the finger) touching the thumb 46 and in close proximity to transmitter T1 on the thumb 46 to a subsequent location T2b away from the thumb 46 (indicated by a solid outline of the finger 18). Correspondingly, the sensor T2 attached to the finger 18 moves from a starting location T2a to a subsequent location T2b to create a data entry or command for the controlled electronic device(s) 39. Graph 502 of FIG. 10 shows a graphical depiction of sensors T1 and T2a-b relative to a receiver 500 in a three dimensional space with x, y and z coordinates. Transmitter T1 remains still relative to receiver 500 while transmitter T2 moves from location T2a to subsequent location T2b. The processor would interpret this motion and generate an output signal to be translated into the raw spatial data representative of the sensors' spatial locations over time as well as any predetermined commands resulting from spatial locations or motions of the various transmitter(s) T1 and T2 with respect to each other and the receiver 500.

Similarly to FIG. 10, FIG. 11 demonstrates the motion of all sensors on a given hand 12 relative to a receiver 604 and the corresponding spatial motion of sensors on that hand as the whole hand moves from the ghosted position in space to the solid line position in space. In FIG. 11, a user has two sensors T1 and T2 attached to the index finger. The receiver 604 receives the signals from sensors T1 and T2. The hand moves from location 600a (in dashed lines) to subsequent location 600b. Consequently, the transmitters move from location T1a to T1b and T2a to T2b as shown in FIG. 11. Graph 603 demonstrates the spatial motion of the transmitters T1 and T2 on the index finger relative to the receiver 604 as interpreted by the processor. In the graph 603, transmitters are shown to move from starting position T1a and T2a along paths 606 and 605, respectively, to subsequent positions T1b and T2b, respectively. As you will notice the transmitters moved only in relationship to receiver 604 such that T1 and T2 did not move relative to each other. The processor would interpret this motion and output the raw spatial data of the sensors as to the spatial locations of the transmitters over time as well as any predetermined commands resulting from changes to the spatial locations or motions of the transmitters T1 and T2 with respect to the receiver 604.

In addition, if one of the transmitter(s) T1a of FIG. 11 is a passive microchip or nano-chip implanted beneath the skin of the end user hand or index finger, this would provide the security password when energized by the active electronics of the system for identification purposes before output signals are received and processed by the microprocessor of the virtual input device 10. This provides a computer system for the military, government or other businesses requiring security for key employees with very secure passwords that are not lost or misplaced during operation of certain electronic device(s) requiring a high level of security checking before operation of its computing system. And, it prevents unauthorized users with finger transmitters from accessing secure equipment.

For example, a computer system is authorized for use by only user A. Even though user B is outfitted with appropriate transmitters for the virtual input data system at his company on his assigned computer and maybe other personnel computers in a company's facility and user B is standing next to user A and moving his hand in the same predetermined spatial movements as user A (and associated affixed finger transmitters), the secure computer system will only recognize and respond to the transmitter manipulations of user A. This is accomplished by the computer system determining that the transmitters of user A are authorized to access that computer system prior to accepting the control inputs from the virtual input device of user A.

Electronic device(s) 39 are also configured to be activated by transmitters based on the proximity of the user to a particular controlled electronic device(s) 39.

For example, when a user is within a certain distance from the computer, the I/O 31 of the processor 25 will establish a wireless connection with the computer and then the user can begin interfacing with the computer. For example, as shown in FIG. 12A, the end user 600 has ten transmitters T1a-T10a on the hands whose output signals are transmitted to the receiver on a processor 601 of the electronic device 602.

In FIG. 12B, an end user 610 has transmitters T1b-T5b on one hand with an intermediate processor 611 on the arm receiving the output signals from those transmitters and transmitters T6b-T10b on the other hand with an intermediate processor 612 receiving the output signals. An intermediate processor 613 attached to the belt of the user 610 collects the data from intermediate processors 611 and 612 while a transmitter T2 on the foot sends the output signal to an intermediate processor 614. Intermediate processor 614 sends it data to the intermediate processor 613, which in turn sends its data signals to a microprocessor 615 internal to an electronic device 616 to generate the control signals.

Now, in FIG. 12C, an end user 620 makes finger and hand manipulations of transmitter(s) T1c-T10c generating the output signals. The output signals are received by an I/O of a microprocessor 621, which performs the spatial recognition translation on the output signals from transmitter(s) T1c-Tc10 and then takes the raw spatial data and performs a command interpretation on the spatial data to generate a command or control signal 624 which either wired or wireless is sent to a desktop computer 623 to control it. Then when the user leaves the proximity of the desktop computer 623 or other electronic device to be controlled, the connection is terminated.

A low power active or passive transmitter is ideally suited for this type of connectivity with the desktop computer 623 or other electronic device(s). The manufacturer and its attendant transmitters determine this proximity range of a particular device. The end user 620 to achieve the desired predetermined distance preferences before the transmitter motions on manipulated fingers will activate a particular electronic device often configures this proximity range.

In addition, the particular communication method used in keeping with the inventive concept is described as a radio frequency, microwave or any other electromagnetic frequency or bandwidth that is now know or hereafter will be known that is capable of providing a transmission or communication method for the spatial recognition signals that are used to control the electronic device(s) 39. RF, microwave, infrared, optical or other signals provide wavelengths that are used presently or in the future to carry output and control signals for the electronic device(s) 39.

Additional advantages and modification will readily occur to those skilled in the art. Therefore, the invention in its broader aspects is not limited to the specific details and representative embodiments as shown and described herein. Accordingly, various modifications may be made without departing from the spirit or scope of the general inventive concept as defined by the appended claims and their equivalents.

I claim:

1. A virtual input apparatus for computing that uses manipulations by an end user to generate data or command signals for a human machine interface to control a host of various devices activated by said data or command signals, comprising:
a transmitter(s) located within manipulation distance of an end user having a signal output corresponding to said manipulations;
a receiver for picking up said signal output;
electronics connected to the receiver for converting the signal output into raw spatial data representative of the manipulation of the transmitter(s): and a program run on said electronics to process the raw spatial data into a predetermined interpreted command format for operating a selected device.

2. The virtual input apparatus of claim 1, wherein the manipulated transmitters are located on the body of the end user and the transmitters are inexpensive and disposable units.

3. The virtual input apparatus of claim 1, wherein the manipulated transmitters are on an object manipulated by the end user.

4. The virtual input apparatus of claim 1, wherein said transmitter(s) are located on the clothing of the end user.

5. The virtual input apparatus of claim 1, wherein said transmitter(s) are surgically implanted beneath the skin of the end user.

6. The virtual input apparatus of claim 1, wherein the transmitter(s) are energized by the electronics through the receiver to create the signal output.

7. The virtual input apparatus of claim 1, wherein the signal output is an electromagnetic transmission

8. The virtual input apparatus of claim 2, wherein said transmitter(s) are attached to a fingernail, an elbow, a hand, a leg or other body part that are manipulated by the end user to create data by measuring the movement of the transmitters in a predefined pattern with respect to one another and to the receiver, whereby the user can easily remove a damaged transmitter from the body and replace or relocate a new transmitter on the body.

9. The virtual input apparatus of claim 1, wherein said electronics includes a microprocessor executing first a spatial recognition translation program to generate the raw spatial data, said raw spatial data is then fed to the command interpreter program to generate a command signal for operating the devices.

10. The virtual input apparatus of claim 1 wherein said receiver includes multiple inputs to generate a triangulation signal input from each transmitter to the electronics for generating the raw spatial data.

11. The virtual input apparatus of claim 1, wherein said program is a predefined command interpreter program corresponding to the body manipulations to generate the input command signals for a particular device to be operated.

12. The virtual input apparatus of claim 1 wherein said electronics includes an encoding program to encrypt the data for device security and wherein the various devices include a decoding electronics to read the encrypted data before the devices can be operated.

13. The virtual input apparatus of claim 1 wherein said electronics is a microprocessor.

14. The virtual input apparatus of claim 1, wherein said electronics are located within an intermediate receiver/transmitter housing located on or about the body of the end user to receive transmitter(s) output signals in order to relay the output signals to a source of further processing.

15. The virtual input apparatus of claim 14, wherein, the housing is a bracelet, elastic band, watch, jewelry or other article worn on the body to receive the transmitter(s) output signals when a low level output signal is generated by the transmitter(s) to make sure the output signals are properly relayed and received by the microprocessor.

16. The virtual input apparatus of claim 1 wherein the transmitter(s) are small in size and discretely located on a fingernail.

17. The virtual input apparatus of claim 1, wherein the transmitter(s) are implanted surgically beneath the skin of a finger or hand on the body of the end user.

18. The virtual input apparatus of claim 16 wherein said transmitter(s) are passive or active and concealable on the fingernail or surgically implanted beneath the skin on a hand of the end user to additionally prevent moisture or physical damage to the transmitter(s).

19. The virtual input apparatus of claim 18, wherein the passive transmitter(s) are a Radio Frequency ID (RFID) film or chip.

20. The virtual input apparatus of claim 1 wherein said transmitter(s) are affixed to an elastic band that fits around fingers on a hand or around a wrist of the end user.

21. The virtual input apparatus of claim 1 wherein said transmitter(s) are affixed to a ring worn on a finger of a hand or an elastic band around a wrist of the end user.

22. The virtual input apparatus of claim 1 wherein said electronics include a microprocessor having an interpret pre-set commands program matching predefined commands based upon the raw spatial data of absolute locations of the transmitter(s) with respect to the receiver and relative to the locations of the transmitter(s) with respect to each other to generate the data or control signals for the various devices to be operated.

23. The virtual input apparatus of claim 1 further including transmitter(s) affixed to a fingernail of the body and having an intermediate microprocessor in proximity of the transmitter(s) to feed command signals from the microprocessor to the various devices to be controlled.

24. A virtual input data system for inputting data into a computing device, comprising:
two or more transmitter(s) are removably affixed, attached, or worn on the body of a user and manipulated in space to generate data corresponding to said manipulations;
receiver in sensing distance from said transmitter(s) to wirelessly receive said data; and
electronics connected to said receiver for translating the data and for creating entry and control data and for outputting to the computing device.

25. The virtual input data system of claim 24, wherein the transmitters are inexpensive and disposable units that is easily replaceable in the event of damage thereto.

26. The virtual input data system of claim 24, wherein the electronics comprises a microprocessor, memory, and spatial and command software programs for translating data and for transforming data into the entry and control data for the computing device.

27. The virtual input data system of claim 24, wherein the entry and control data outputting to the computing device is done wirelessly.

28. A virtual method of inputting data into a computing device from interpretive spatial movements of a user, the method comprising:
creating data by manipulating transmitter(s) within the control of the user;
receiving the created data wirelessly;
interpreting the created data with a microprocessor;
transforming the created data into command data with the microprocessor; and
outputting wirelessly the command data to the computing device to control the operation thereof.

29. The virtual method of inputting data of claim 27, wherein the transmitters are located on the body of the end user and are inexpensive, affixable to wear on the body or clothing and disposable to be replaced by new transmitters when inadvertently lost or damaged during use.

30. The virtual method of inputting data of claim 27, wherein the transmitters are active or passive transmitters located on the fingernails of the end user.

31. The virtual method of inputting data of claim 27, wherein the interpreting and transforming of created data into the command data further includes a memory associated with the microprocessor for storing software programs operative on the created data.

32. A method for generating operating commands to a machine from a virtual input apparatus by body and/or object manipulations, comprising the steps of:
a. attaching at least two or more transmitters at various locations on a body and/or object manipulated by the end user;
b. sensing the manipulation of the transmitters on the body and/or object with respect to each other or to a predetermined point as the end user creates a motion of the attached transmitters to generate output signals;
c. receiving and translating the output signals into raw spatial data corresponding to the body and/or object manipulations from the end user;
d. feeding the raw spatial data into a command interpreter to provide control signals that can be read by the machine; and
e. delivering the control signals to the machine.

33. The method of claim 31 wherein said step of attaching at least two or more transmitters on the body includes attaching passive or active transmitters to the body.

34. The method of claim 31 wherein said step of attaching said transmitters to the body of the end user involves the use of elastic bands with the transmitters incorporated therein to facilitate the attachment to digits or wrist on the hand, whereby the end user can easily remove the transmitters from one finger, thumb, wrist or hand, and then replace the transmitter on a finger, thumb, wrist or hand when the transmitters becomes lost or damaged through use.

35. The method of claim 31 wherein said step of attaching transmitters includes the use of a ring on the finger or a bracelet or watch on the wrist with the transmitter embedded therein for ease of removing or replacing damaged transmitters.

36. The method of claim 31 wherein said step of attaching transmitters involves a surgical implanting of the transmitters under the skin of a hand on the body for protecting the transmitters from extreme temperatures and moisture, whereby said attachment of the transmitters is a more permanent attachment to the body.

37. The method of claim 31 wherein the receiving and translating of the transmitters output signals are done by a microprocessor having pre-set commands built into translation and interpreter programs for controlling a particular machine operation.

38. The method of claim 31 wherein the raw spatial data can be fed directly into the machine that already includes an interpretive program capable of converting the raw spatial data into operating command signals for the machine.

39. A virtual input apparatus generating controls signals to operate electronic devices or a computing system corresponding to a spatial manipulation of body parts in a certain predefined coordinated patterns of motion by the end user, comprising:
transmitter(s) mounted on body parts easily manipulated to generate output signals corresponding to the patterns of motion of the transmitter(s) with respect to each other and to a predetermined point(s);
receiver(s) located in proximity to the transmitter(s) to pick up any output signals therefrom and to act as the predetermined point(s); electronic circuitry connected to the receiver(s) for processing and transforming the output signals from the transmitter(s) into raw spatial data; and
an interpreter commands program associated with the electronics for a selected electronic device turning the raw spatial data into control signals to operate the electronic device.

40. The virtual input apparatus of claim 39 wherein said transmitter(s) generated output signals are electromagnetic transmissions, such as but not limited to radio frequency or microwave frequency.

41. The virtual input apparatus of claim 40 wherein the transmitter(s) producing the electromagnetic transmissions are either passive or active transmitter chips or film of de minimus size.

42. The virtual input apparatus of claim 39, wherein said receiver includes multiple receivers sensing each output signal from the transmitter(s) to triangulate each transmitter output origin to create the raw spatial data of said transmitters for processing into the control signals.

43. The virtual input apparatus of claim 39, further including a microprocessor with a memory storing a spatial recognition translation program for transforming the electromagnetic transmissions from the transmitter(s) into the raw spatial data and further includes a predefined interpreter commands program stored in said memory for converting the raw spatial data into the control signals for the electronic device.

44. The virtual input apparatus of claim 39 wherein said transmitter(s) and electronics with the interpreter commands program forms the firmware to control the electronic devices.

45. The virtual input apparatus of claim 39 further including a band suitable to wear around digits on a hand, a wrist, an arm, and/or a leg, wherein the transmitter(s) are affixed to the bands to create additional output signals corresponding to the motion of the additional transmitter(s) mounted on the bands with respect to each other and/or to other transmitter(s) located on designated body parts and/or to predetermined point(s).

46. The virtual input apparatus of claim 39, further including a bracelet or watch worn around a wrist on a hand wherein the electronic circuitry including the receiver(s), a microprocessor and the interpreter commands program are incorporated into the bracelet in order to receive the output signals from the transmitter(s) and wherein the bracelet further includes a wireless input/output (I/O) circuit for sending and receiving control signals to and from the electronic device.

46. The virtual input apparatus of claim 39, wherein the electronic circuitry is incorporated into the electronic device to be controlled and the receiver(s) is capable of picking up the output signals from the transmitter(s) when in proximity to an end user or when the electronic device is held in a hand of the end user.

48. The virtual input apparatus of claim 46, wherein the bracelet or watch including the electronics is worn on each wrist of the hand to receive the output signals from the transmitter(s) on each hand, respectively, to combine the raw spatial data from each hand and process said spatial data into the control signals and then to send the resulting control signals wirelessly to the electronic device.

49. The virtual input apparatus of claim 46, wherein the bracelet or watch electronic circuitry forms an intermediate processor including an I/O, which picks up low energy output signals from the transmitter(s) located on any body part or clothing on the body of an end user and relay the output signals from the transmitter(s) to the intermediate processor I/O to a final processor system having an I/O to receive said transmission, said final processor combining all of the raw spatial data into the final control signals for the electronic device to be controlled.

50. The virtual input apparatus of claim 45, wherein the band incorporating the transmitter(s) are disposable when worn out and easily replaced with another band and its transmitter and wherein the band is an elastic material that stretches and contracts to fit all size fingers, hands, wrists and legs comfortably.

51. The virtual input apparatus of claim 39 further including transmitter(s) located on an arm, wrist, elbow, leg, ankle, foot, or adjacent clothing of the end user so that additional spatial points are created for generating raw spatial data capable of being interpreted as new commands for the electronic devices.

52. The virtual input apparatus of claim 39 further including an elongated object representing a surgeons scalpel having transmitter(s) located at either end of the object such that the scalpel in conjunction with the other transmitter(s) on the body parts controls an operating room video display and/or the manipulations of an electronic scalpel instrument such as a laser wand during microsurgery on a patient.

53. The virtual input apparatus of claim 38, further including a generally elongated object having transmitter(s) thereon representing an article to perform a predetermined function in a computing system.

54. The virtual input apparatus of claim 39, further including generally small, discrete transmitter(s) implanted through surgery beneath the skins surface on a finger, hand or arm of the end user to protect the transmitter(s) from elements of temperature, abrasion and moisture that degrade the transmitter(s) over a period of time.

55. The virtual input apparatus of claim 54, wherein the transmitter(s) generate radio frequencies, microwaves, radiating isotopes, or other electromagnetic output signals that are picked up by the receiver(s) in proximity thereto.

56. The virtual input apparatus of claim 39, wherein the control signals are encrypted for security purposes in which the electronic device to be controlled decrypts the data prior to permitting the command signals to operate the computing system or other electronic device.

57. The virtual input apparatus of claim 39, further including a peer-to-peer network between at least two end users in which the output signals from the transmitter(s) attached to each end user are fed to respective microprocessors for processing and coordinating output signals together over the peer-to-peer network to create a single set of control signals that are then transmitted via a wired or wireless communication method from one of the microprocessors to operate the electronic device(s).

58. The virtual input apparatus of claim 57, wherein the networked control signals are transmitted by the microprocessor of each end user to the electronic device(s).

59. The virtual input apparatus of claim 39, further including a network interface connected to a peer-to-peer network between at least two end users to handle the respective processed output signals from each end user transmitter(s), said network interface collecting the various processed output signals from the end users is in turn connected to a remote network for further processing of the control signals which are then fed to the controlled electronic device(s).

60. The virtual input apparatus of claim 39 connected to a network interface by wired or wireless method, with said network interface then transmitting the control signals from the virtual input apparatus to a local and/or remote network, with the electronic device(s) connected to said network and capable of accepting control data over said network

61. The virtual input apparatus of claim 60, further including a third end user having transmitter(s), a microprocessor and a connection to another network interface, said another network interface is connected to the Internet which in turn is connected to the remote interface for transmitting the control signals from the third end user wherein all of the end users microprocessors are networked together through the respective network interfaces to the remote network for collaboratively combining the control signals with respect to each other for operating the electronic device(s).

62. The virtual input apparatus of claim 57, wherein each of the end users transmitter(s) include an identifier that is processed by the microprocessor so that the control signals from each end user can be associated with that specific user.

63. The virtual input apparatus of claim 59, wherein the number of end users is essentially unlimited as well as the number of network interfaces and the remote device work collaboratively with each network interface to combine the control signals fed to the electronic device.

64. The virtual input apparatus of claim 39, further including an intermediate signal processor connected either through a wired or wireless communications method to various electronic device(s) for relaying the control signals onto the controlled electronic device(s).

65. The virtual input apparatus of claim 64, wherein the intermediate signal processor encrypts the transmission data, which is then decrypted by an authorized electronic device(s) prior to acceptance of the control signals.

66. The virtual input apparatus of claim 62, wherein the identifier in the transmitter(s) is an electronic code in the circuitry of the transmitter(s).

67. The virtual input apparatus of claim 39, wherein at least one of the transmitter(s) is a passive micro or nano chip implanted beneath the skin of the end user in any convenient location on the body of the end user but suitable to be implanted in a hand or its digits to provide a security password when energized by the active electronics of the system for identification purposes before any output signals from the transmitters are received and processed by the microprocessor.

68. A method for inputting control signals into an electronic device, comprising the steps of:
attaching strategic transmitter(s) on the body of the end user to provide a source of signal outputs;
placing receiver(s) in proximity to said transmitter(s) for sensing signal outputs;
manipulating parts of the body in a predetermined spatial pattern to create the desired sensed signal outputs;
transforming the desired output signals into raw spatial data;
interpreting the raw spatial data to correspond with a set of control signals for operating the electronic device; and
outputting the control signals via a wired or wireless communication with the electronic device to be controlled.

69. The method of claim 68 wherein said step of attaching strategic transmitters means affixing the transmitter(s) to convenient locations including the fingertips, fingernails, fingers, hand, arm, elbow, leg or other suitable body parts and to articles of clothing on the body.

70. The method of claim 68 wherein said step of attaching strategic transmitter(s) include implanting a transmitter beneath the skin for security, protection and other purposes and wherein the transmitter(s) are either micro or nano chips or isotopes.

71. The method of claim 68 wherein said step of attaching strategic transmitter(s) include affixing the transmitter(s) in location on the body for ease of removal and replacement when damaged during use.

72. The method of claim 68 wherein said step of placing receiver(s) in close proximity of transmitter(s) includes placing the receiver(s) in a bracelet or watch to be worn on the wrist of the body.

73. The method of claim 68, wherein said step of placing receiver(s) in close proximity of transmitter(s) includes placing the receiver(s) at a belt on the waist of the body.

74. The method of claim 68, wherein said manipulating of body parts to create the desired spatial patterns includes moving fingers and hand with transmitters affixed thereon that provide a multitude of different predetermined spatial patterns and juxtaposed position of the transmitters to represent the functions on a keyboard, the operation of a computer mouse or even a set of standard control signals for a given electronic device.

75. The method of claim 68, wherein the control signals provide adjustments to the volume, channel and recording or playing instructions for a TV, DVD, VCR or TIVO players connected to the TV.

76. The method of claim 68, wherein said transforming of output signal into raw spatial data is accomplished by a microprocessor having a program therein capable of translating the output signals from the transmitter(s) into raw spatial data.

77. The method of claim 68, wherein said interpreting of the raw spatial data is done by an interpret commands program run on a microprocessor for developing the outputted control signals to the electronic device.

78. The method of claim 68, wherein said outputting of the control signals is done by an output/input circuitry of a microprocessor feeding the control signals via a wired or wireless communication protocol adapted by a particular electronic device.

79. A method for controlling electronic device(s) by sensing predetermined patterns of motion of the end user body parts to represent the control signals to operate the electronic device, comprising the steps of:
receiving predetermined patterns of motion from various body parts of the end user from transmitter(s);
affixing said transmitter(s) to the human body in a preselected location so that said transmitter(s) generate spatial relationships when manipulated by motion of the body parts;
further affixing one or more transmitter(s) beneath the skin of the body to avoid accidental transmitter(s) damage due moisture, temperature or abrasion;
outputting signals from said transmitter(s) corresponding to said predetermined patterns of motion from the body parts;
translating the output signals from said transmitter(s) into raw spatial data corresponding to the patterns of motion;
interpreting the raw spatial data corresponding to the patterns of motion of the transmitter(s) to generate control signals that can operate the electronic device; and
outputting said control signals to said electronic device.

80. The method of claim 79, wherein said step of receiving predetermined patterns of motion include the movement of body parts with respect to one another includes a receiver located in a close proximity to the transmitter(s)

81. The method of claim 79, wherein said step of affixing transmitter(s) beneath the skin includes the use of micro or nano electronic chips that give off a radio signal or an isotope that gives of a radiated signal, both signals are capable of being sensed by a receiving means.

82. The method of claim 79 wherein said step of affixing transmitter(s) on a part of the body includes placing or affixing the transmitter(s) to articles of clothing whereby said transmitter(s) are disposable, relocatable and replaceable to create new predetermined patterns of motion corresponding to new control signals for the electronic device.

83. The method of claim 79 wherein said steps of translating and interpreting are accomplished in a microprocessor capable of running a host of different programs responsive to the various output signals and raw spatial data respectively, to change the controls signals to match the type of electronic device(s) desired to be operated.
